(19) United States
(12) Patent Application Publication
(10) Pub. No.: US 2023/0174411 A1
(43) Pub. Date: Jun. 8, 2023

(54) GLASS COMPOSITIONS FOR FORMING COLORED GLASS ARTICLES AND GLASS ARTICLES FORMED THEREFROM

(71) Applicant: CORNING INCORPORATED, Corning, NY (US)

(72) Inventors: Xiaoju Guo, Pittsford, NY (US); Jesse Kohl, Horseheads, NY (US); Nicole Taylor Wiles, Horseheads, NY (US)

(21) Appl. No.: 17/992,335

(22) Filed: Nov. 22, 2022

Related U.S. Application Data
(60) Provisional application No. 63/286,316, filed on Dec. 6, 2021.

(51) Int. Cl. C03C 4/02; C03C 3/085

(52) U.S. Cl. CPC C03C 4/02; C03C 3/085

(57) ABSTRACT

Colored glass articles and methods for making the same are described herein. In embodiments, a colored glass article may include 50 mol. % to 70 mol. % SiO₂; 10 mol. % to 20 mol. % Al₂O₃; 4 mol. % to 10 mol. % B₂O₃; 7 mol. % to 17 mol. % Li₂O; 1 mol. % to 9 mol. % Na₂O; 0.01 mol. % to 1 mol. % SnO₂; and 0.01 mol. % to 5 mol. % Ag. The difference between R₂O and Al₂O₃(R₂O—Al₂O₃) may be greater than 0.2 mol. % and less than or equal to 5.00 mol. % where R₂O is the sum of Li₂O, Na₂O, and K₂O.

This application claims the benefit of priority of U.S. Provisional Application Ser. No. 63/286,316 filed on Dec. 6, 2021, the content of which is relied upon and incorporated herein by reference in its entirety.

### FIELD

The present disclosure relates to glass compositions and, in particular, glass compositions for forming colored glass articles that have not been subjected to mechanical stretching processes and are substantially free of halides.

### TECHNICAL BACKGROUND

As consumer electronic devices, such as smart phones, tablets and the like, shift into the “mm wave” regime (i.e., the use of radio waves having a frequency of 5 GHz to 40 GHz), glass articles have been the most common material for housing these devices because glass does not attenuate radio waves like metal and offers superior scratch resistance compared to plastic. While glass articles used for housing consumer electronic devices are typically transparent, coloration and decoration has been conventionally achieved using inks, films, and/or coatings. Colored glass articles may provide a unique aesthetic and eliminate extra process steps associated with the application of inks, films, and/or coatings.

However, conventional methods for achieving colored glass articles either require the inclusion of undesirable components in the glass composition, such as halides, and/or require additional processing steps, such as mechanical stretching, to achieve a limited range of colors.

Accordingly, a need exists for alternative colored glass compositions for forming colored glass articles having a broad range of colors without comprising halides and/or being subjected to mechanical stretching processes.

### SUMMARY

A first aspect of the present disclosure includes a colored glass article comprising: greater than or equal to 50 mol. % and less than or equal to 70 mol. % SiO₂; greater than or equal to 10 mol. % and less than or equal to 20 mol. % Al₂O₃; greater than or equal to 4 mol. % and less than or equal to 10 mol. % B₂O₃; greater than or equal to 7 mol. % and less than or equal to 17 mol. % Li₂O; greater than or equal to 1 mol. % and less than or equal to 9 mol. % Na₂O; greater than or equal to 0.01 mol. % and less than or equal to 1 mol. % SnO₂; and greater than or equal to 0.01 mol. % and less than or equal to 5 mol. % Ag, wherein R₂O—Al₂O₃ is greater than 0.2 mol. % and less than or equal to 5.00 mol. % and R₂O is the sum of Li₂O, Na₂O, and K₂O.

A second aspect of the present disclosure includes the colored glass article of the first aspect, wherein the colored glass article is substantially free of halides.

A third aspect of the present disclosure includes the colored glass article of any of the first through third aspects, wherein the colored glass article, comprises randomly oriented silver particles, the silver particles comprising an aspect ratio greater than 1.

A fourth aspect of the present disclosure includes the colored glass article of any of the first through third aspects, wherein the colored glass article comprises greater than or equal to 0.2 mol. % and less than or equal to 1 mol. % K₂O.

A fifth aspect of the present disclosure includes the colored glass article of any of the first through fourth aspects, wherein the colored glass article comprises greater than or equal to 0.05 mol. % and less than or equal to 4 mol. % CeO₂.

A sixth aspect of the present disclosure includes the colored glass article of any of the first through fifth aspects, wherein the colored glass article comprises greater than or equal to 0.1 mol. % and less than or equal to 4 mol. % Nd₂O₃.

A seventh aspect of the present disclosure includes the colored glass article of any of the first through sixth aspects, wherein the colored glass article comprises greater than or equal to 0.1 mol. % and less than or equal to 4 mol. % Er₂O₃.

An eighth aspect of the present disclosure includes the colored glass article of any of the first through seventh aspects, wherein the colored glass article is non-polarized.

A ninth aspect of the present disclosure includes the colored glass article of any of the first through eighth aspects, wherein an absorbance spectra of the glass article comprises two distinct peaks.

A tenth aspect of the present disclosure includes the colored glass article of any of the first through ninth aspects, wherein: the colored glass article comprises a thickness (τ_{w}) less than or equal to 3.00 mm; the colored glass article has an average transmittance greater than 90% for wavelengths greater than or equal to 780 nm and less than or equal to 2,000 nm; and the colored glass article has an average transmittance less than 3% for wavelengths greater than or equal to 380 nm and less than 750 nm.

An eleventh aspect of the present disclosure includes the colored glass article of any of the first through tenth aspects comprising: greater than or equal to 53 mol. % and less than or equal to 65 mol. % SiO₂; greater than or equal to 14 mol. % and less than or equal to 17 mol. % Al₂O₃; greater than or equal to 5 mol. % and less than or equal to 7 mol. % B₂O₃; greater than or equal to 11 mol. % and less than or equal to 14 mol. % Li₂O; greater than or equal to 4 mol. % and less than or equal to 7 mol. % Na₂O; and greater than or equal to 0.1 mol. % and less than or equal to 1 mol. % Ag, wherein R₂O—Al₂O₃ is greater than 0.50 mol. % and less than or equal to 4.50 mol. %.

A twelfth aspect of the present disclosure includes the colored glass article of any of the first through eleventh aspects, wherein the colored glass article has a transmitted color coordinate in the CIELAB color space of: L* greater than or equal 20 and less than or equal to 90; and a* and b* values within a region of a plot of a* vs. b* bound by the intersection of lines: b*=0.2879·a*+27.818; b*=7.0833·a*−94.5; b*=0.45·a*+104.5; and b*=15.3·a*+253.

A thirteenth aspect of the present disclosure includes the colored glass article of any of the first through twelfth aspects, wherein the colored glass article has a transmitted color coordinate in the CIELAB color space of: L* greater than or equal 20 and less than or equal to 90; and a* and b* values within a region of a plot of a* vs. b* bound by the intersection of lines: b*=7.0833·a*−94.5; b*=−0.9583·a*+146.75; b*=2.6957·a*−50.565; and b*=33.

A fourteenth aspect of the present disclosure includes the colored glass article of any of the first through thirteenth aspects, wherein the colored glass article has a transmitted color coordinate in the CIELAB color space of: L* greater than or equal 20 and less than or equal to 90; and a* and b* values within a region of a plot of a* vs. b* bound by the intersection of lines: b*=2.6957·a*−50.565; a*=54; b*=1.0769·a*−17.154; and b*=6.6667·a*−173.67.

A fifteenth aspect of the present disclosure includes the colored glass article of any of the first through fourteenth aspects, wherein the colored glass article has a transmitted color coordinate in the CIELAB color space of: L* greater than or equal 4 and less than or equal to 80; and a* and b* values within a region of a plot of a* vs. b* bound by the intersection of lines: b*=0.2879·a*+27.818; a*=0; b*=−1.375·a*+1; and b*=9.333·a*+86.667.

A sixteenth aspect of the present disclosure includes the colored glass article of any of the first through fifteenth aspects, wherein the colored glass article has a transmitted color coordinate in the CIELAB color space of: L* greater than or equal 10 and less than or equal to 80; and a* and b* values within a region of a plot of a* vs. b* bound by the intersection of lines: b*=0.0833·a*+20.833; b*=2.1182·a*−32.073; b*=−0.3; and b*=1.5929·a*−0.3.

A seventeenth aspect of the present disclosure includes a glass composition comprising: greater than or equal to 50 mol. % and less than or equal to 70 mol. % SiO₂; greater than or equal to 10 mol. % and less than or equal to 20 mol. % Al₂O₃; greater than or equal to 4 mol. % and less than or equal to 10 mol. % B₂O₃; greater than or equal to 7 mol. % and less than or equal to 17 mol. % Li₂O; greater than or equal to 1 mol. % and less than or equal to 9 mol. % Na₂O; greater than or equal to 0.01 mol. % and less than or equal to 1 mol. % SnO₂; and greater than or equal to 0.01 mol. % and less than or equal to 5 mol. % Ag, wherein R₂O—Al₂O₃ is greater than 0.2 mol. % and less than or equal to 5 mol. % when R₂O is the sum of Li₂O, Na₂O, and K₂O.

An eighteenth aspect of the present disclosure includes the glass composition of the seventeenth aspect, wherein the glass composition is substantially free of halides.

A nineteenth aspect of the present disclosure includes the glass composition of any of the seventeenth through eighteenth aspects, wherein the colored glass article comprises greater than or equal to 0.2 mol. % and less than or equal to 1 mol. % K₂O.

A twentieth aspect of the present disclosure includes the glass composition of any of the seventeenth through nineteenth aspects, wherein the colored glass article comprises greater than or equal to 0.05 mol. % and less than or equal to 4 mol. % CeO₂.

A twenty-first aspect of the present disclosure includes the glass composition of any of the seventeenth through twentieth aspects, wherein the colored glass article comprises greater than or equal to 0.1 mol. % and less than or equal to 4 mol. % Nd₂O₃.

A twenty-second aspect of the present disclosure includes the glass composition of any of the seventeenth through twenty-first aspects, wherein the colored glass article comprises greater than or equal to 0.1 mol. % and less than or equal to 4 mol. % Er₂O₃.

A twenty-third aspect of the present disclosure includes the glass composition of any of the seventeenth through twenty-second aspects, wherein R₂O—Al₂O₃ is greater than 0.50 mol. % and less than or equal to 4.50 mol. % and R₂O is the sum of Li₂O, Na₂O, and K₂O.

A twenty-fourth aspect of the present disclosure includes the glass composition of any of the seventeenth through twenty-third aspects comprising: greater than or equal to 53 mol. % and less than or equal to 65 mol. % SiO₂; greater than or equal to 14 mol. % and less than or equal to 17 mol. % Al₂O₃; greater than or equal to 5 mol. % and less than or equal to 7 mol. % B₂O₃; greater than or equal to 11 mol. % and less than or equal to 14 mol. % Li₂O; greater than or equal to 4 mol. % and less than or equal to 7 mol. % Na₂O; and greater than or equal to 0.1 mol. % and less than or equal to 1 mol. % Ag, wherein R₂O—Al₂O₃ is greater than 0.50 mol. % and less than or equal to 4.50 mol. %.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF THE DRAWINGS

The following detailed description may be better understood when read in conjunction with the following drawings, in which:

FIG. 1A graphically depicts a plot of projected a* vs. L* CIELAB spaces (y-axis: a*; x-axis: L*) of colored glass articles according to one or more embodiments of the present disclosure;

FIG. 1B graphically depicts a plot of projected b* vs. L* CIELAB spaces (y-axis: b*; x-axis: L*) of colored glass articles according to one or more embodiments of the present disclosure;

FIG. 1C graphically depicts a plot of projected a* vs. b* CIELAB spaces (y-axis: b*; x-axis: a*) of colored glass articles according to one or more embodiments of the present disclosure;

FIG. 2A graphically depicts a plot of projected a* vs. L* CIELAB spaces (y-axis: a*; x-axis: L*) of colored glass articles according to one or more embodiments of the present disclosure;

FIG. 2B graphically depicts a plot of projected b* vs. L* CIELAB spaces (y-axis: b*; x-axis: L*) of colored glass articles according to one or more embodiments of the present disclosure;

FIG. 2C graphically depicts a plot of projected a* vs. b* CIELAB spaces (y-axis: b*; x-axis: a*) of colored glass articles according to one or more embodiments of the present disclosure;

FIG. 3 graphically depicts absorbance spectra (y-axis) as a function of wavelength (x-axis) of colored glass articles according to one or more embodiments of the present disclosure;

FIG. 4 graphically depicts absorbance spectra (y-axis) as a function of wavelength (x-axis) of colored glass articles according to one or more embodiments of the present disclosure;

FIG. 5 graphically depicts absorbance spectra (y-axis) as a function of wavelength (x-axis) of colored glass articles according to one or more embodiments of the present disclosure;

FIG. 6 graphically depicts absorbance spectra (y-axis) as a function of wavelength (x-axis) of colored glass articles according to one or more embodiments of the present disclosure;

FIG. 7 graphically depicts absorbance (y-axis) as a function of wavelength (x-axis) spectra of colored glass articles according to one or more embodiments of the present disclosure;

FIG. 8A graphically depicts a plot of a projected a* vs. L* CIELAB space (y-axis: a*; x-axis: L*) of a colored glass article according to one or more embodiments of the present disclosure;

FIG. 8B graphically depicts a plot of a projected b* vs. L* CIELAB space (y-axis: b*; x-axis: L*) of a colored glass article according to one or more embodiments of the present disclosure;

FIG. 8C graphically depicts a plot of a projected a* vs. b* CIELAB space (y-axis: b*; x-axis: a*) of a colored glass article according to one or more embodiments of the present disclosure;

FIG. 9 graphically depicts an absorbance spectra (y-axis) as a function of wavelength (x-axis) of colored glass articles according to one or more embodiments of the present disclosure;

FIG. 10A graphically depicts a plot of a projected b* vs. L* CIELAB space (y-axis: b*; x-axis: L*) of a colored glass article according to one or more embodiments of the present disclosure;

FIG. 10B graphically depicts a plot of a projected a* vs. b* CIELAB space (y-axis: b*; x-axis: a*) of a colored glass article according to one or more embodiments of the present disclosure;

FIG. 10C graphically depicts a plot of a projected a* vs. L* CIELAB space (y-axis: a*; x-axis: L*) of a colored glass article according to one or more embodiments of the present disclosure;

FIG. 11 graphically depicts an absorbance spectra (y-axis) as a function of wavelength (x-axis) of a colored glass article according to one or more embodiments of the present disclosure;

FIG. 12A is a transmission electron microscopy (TEM) micrograph of anisotropic silver particles in a colored glass article according to one or more embodiments of the present disclosure;

FIG. 12B is a magnified view of a portion of the TEM micrograph of FIG. 12A showing an anisotropic silver particle in a colored glass article according to one or more embodiments of the present disclosure;

FIG. 12C is a magnified view of a portion of the TEM micrograph of FIG. 12C showing an anisotropic silver particle in a colored glass article according to one or more embodiments of the present disclosure;

FIG. 13 graphically depicts a transmittance spectra (y-axis) as a function of wavelength (x-axis) of a colored glass article according to one or more embodiments of the present disclosure;

FIG. 14 graphically depicts a transmittance spectra (y-axis) as a function of wavelength (x-axis) of a colored glass article heat treated at the same temperature for different heat treatment times, according to one or more embodiments of the present disclosure;

FIG. 15 graphically depicts a transmittance spectra (y-axis) as a function of wavelength (x-axis) of a colored glass article according to one or more embodiments of the present disclosure;

FIG. 16 graphically depicts a transmittance spectra (y-axis) as a function of wavelength (x-axis) of a colored glass article according to one or more embodiments of the present disclosure;

FIG. 17 is a plan view of an electronic device incorporating any of the colored glass articles according to one or more embodiments described herein;

FIG. 18 is a perspective view of the electronic device of FIG. 17;

FIG. 19 is a perspective view of a sensor device incorporating any of the colored glass articles according to one or more embodiments described herein; and

FIG. 20 is graphically depicts a plot of a projected a* vs. b* CIELAB space (y-axis: b*; x-axis: a*) of colored glass articles according to one or more embodiments of the present disclosure.

### DETAILED DESCRIPTION

The present disclosure relates to glass compositions and, in particular, glass compositions used to achieve colored glass articles that are substantially free of halides and have not been subjected to mechanical stretching processes. Reference will now be made in detail to various embodiments of glass compositions for forming colored glass articles, some of which are illustrated in the accompanying drawings.

As used in the present disclosure, the singular forms “a,” “an” and “the” include plural referents unless the context clearly dictates otherwise. Thus, for example, reference to “a” component includes aspects having two or more such components, unless the context clearly indicates otherwise.

As used in the present disclosure, ranges may be expressed as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used in the present disclosure, directional terms—for example up, down, right, left, front, back, top, bottom—are made only with reference to the figures as drawn and are not intended to imply absolute orientation.

As used in the present disclosure, the term “softening point” refers to the temperature at which the viscosity of the glass composition is 1×10^{7.6} poise. The softening point is measured according to the parallel plate viscosity method, which measures the viscosity of inorganic glass from 10⁷ to 10⁹ poise as a function of temperature, similar to ASTM C1351M.

As used in the present disclosure, the term “annealing point” refers to the temperature at which the viscosity of the glass composition is 1×10^{13.18} poise.

As used in the present disclosure, the term “strain point” as refers to the temperature at which the viscosity of the glass composition is 1×10^{14.68} poise.

As used in the present disclosure, the terms “linear coefficient of thermal expansion” and “CTE” are measured in accordance with ASTM E228-85 averaged over the temperature range of 25° C. to 300° C. and are expressed in terms of “×10⁻⁷/° C.”

The term “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 100 ppm.

The terms “0 mol %” and “free,” when used to describe the concentration and/or absence of a particular constituent component in a glass composition, means that the constituent component is not present in the glass composition.

In embodiments of the glass compositions described herein, the concentrations of constituent components (e.g., SiO₂, Al₂O₃, and the like) are specified in mole percent (mol %) on an oxide basis, unless otherwise specified.

Transmittance data (total transmittance and diffuse transmittance) in the visible spectrum is measured with a Lambda 950 UV/Vis/NIR Spectrophotometer manufactured by PerkinElmer Inc. (Waltham, Mass. USA). The Lambda 950 apparatus was fitted with a 150 mm integrating sphere. Data was collected using an open beam baseline and a Spectralon® reference reflectance disk. For total transmittance (Total Tx), the sample is fixed at the integrating sphere entry point.

The term “average transmittance,” as used herein with respect to the visible spectrum, refers to the average of transmittance measurements made within a given wavelength range with each whole numbered wavelength weighted equally. In embodiments described herein, the “average transmittance” with respect to the visible spectrum is reported over the wavelength range from 380 nm to 750 nm (inclusive of endpoints).

Transmittance data (total transmittance and diffuse transmittance) in the infrared spectrum is measured with a Lambda 950 UV/Vis/NIR Spectrophotometer manufactured by PerkinElmer Inc. (Waltham, Mass. USA). The Lambda 950 apparatus was fitted with a 150 mm integrating sphere. Data was collected using an open beam baseline and a Spectralon® reference reflectance disk. For total transmittance (Total Tx), the sample is fixed at the integrating sphere entry point.

The term “average transmittance,” as used herein with respect to the infrared spectrum, refers to the average of transmittance measurements made within a given wavelength range with each whole numbered wavelength weighted equally. In embodiments described herein, the “average transmittance” with respect to the infrared spectrum is reported over the wavelength range from 780 nm to 2000 nm (inclusive of endpoints).

As used in the present disclosure, the term “CIELAB color space” refers to a color space defined by the International Commission on Illumination (CIE) in 1976. It expresses color as three values: L* for the lightness from black (0) to white (100), a* from green (−) to red (+), and B* from blue (−) to yellow (+).

As used in the present disclosure, the term “color gamut” refers to the pallet of colors that may be achieved by the colored glass articles within the CIELAB color space.

As used in the present disclosure, the term “projected color gamut” refers to the line, surface, volume, or overlapping volume occupied by the colored glass article within the three-dimensional CIELAB color space and represents the pallet of colors that may be achieved by the colored glass articles within the CIELAB color space based upon the concentration of colorant(s) present in the colored glass article.

Unless otherwise expressly stated, it is in no way intended that any method set forth in the present disclosure be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As noted herein, colored glass articles may provide a unique aesthetic and eliminate extra process steps associated with the application of inks, films, and/or coatings. However, conventional methods for achieving colored glass articles without the use of inks, films, and/or coatings either require the inclusion of undesirable components in the glass composition, such as halides, and/or mechanical stretching processes that can only achieve a limited range of colors.

In contrast, the embodiments of the glass compositions described may be used to form colored glass articles having a broad range of colors without the use of halides or additional processing steps such as mechanical stretching processes. In embodiments, a glass composition and the resulting colored glass article may comprise greater than or equal to 50 mol. % and less than or equal to 70 mol. % SiO₂, greater than or equal to 10 mol. % and less than or equal to 20 mol. % Al₂O₃, greater than or equal to 4 mol. % and less than or equal to 10 mol. % B₂O₃, greater than or equal to 7 mol. % and less than or equal to 17 mol. % Li₂O, greater than or equal to 1 mol. % and less than or equal to 9 mol. % Na₂O, and greater than or equal to 0.01 mol. % and less than or equal to 5 mol. % Ag. In these embodiments, the difference between the concentration of R₂O (i.e., the sum of the alkali metal oxides Li₂O, Na₂O, and K₂O) and Al₂O₃ in the glass composition and the resultant colored glass article (i.e., R₂O—Al₂O₃) is greater than 0.20 mol. % and less than or equal to 5 mol. %.

SiO₂ is the primary glass former in the presently disclosed glass compositions and may function to stabilize the network structure of the colored glass articles. The concentration of SiO₂ in the glass compositions and resultant colored glass articles should be sufficiently high (e.g., greater than or equal to 50 mol. %) to enhance the chemical durability of the glass composition and, in particular, the resistance of the glass composition to degradation upon exposure to acidic solutions, basic solutions, and water. The amount of SiO₂ may be limited (e.g., to less than or equal to 70 mol. %) to control the melting point of the glass composition, as the melting temperature of pure SiO₂ or high SiO₂ glasses is undesirably high. As a result, limiting the concentration of SiO₂ may aid in improving the meltability of the glass composition and the formability of the resultant colored glass article.

Accordingly, in embodiments, the glass composition and the resultant colored glass article may comprise greater than or equal to 50 mol. % and less than or equal to 70 mol. % SiO₂. In embodiments, the glass composition and the resultant colored glass article may comprise greater than or equal to 52 mol. % and less than or equal to 68 mol. % SiO₂, or greater than or equal to 53 mol. % and less than or equal to 65 mol. % SiO₂. In embodiments, the concentration of SiO₂ in the glass composition and the resultant colored glass article may be greater than or equal to 50 mol. %, greater than or equal to 52 mol. %, greater than or equal to 54 mol. %, greater than or equal to 56 mol. %, or even greater than or equal to 58 mol. %. In embodiments, the concentration of SiO₂ in the glass composition and the resultant colored glass article may be less than or equal to 70 mol. %, less than or equal to 68 mol. %, less than or equal to 66 mol. %, less than or equal to 65 mol. %, or less than or equal to 64 mol. %. In embodiments, the concentration of SiO₂ in the glass composition and the resultant colored glass article may be greater than or equal to 50 mol. % and less than or equal to 70 mol. %, greater than or equal to 50 mol. % and less than or equal to 68 mol. %, greater than or equal to 50 mol. % and less than or equal to 66 mol. %, greater than or equal to 50 mol. % and less than or equal to 65 mol. %, greater than or equal to 50 mol. % and less than or equal to 64 mol. %, greater than or equal to 52 mol. % and less than or equal to 70 mol. %, greater than or equal to 52 mol. % and less than or equal to 68 mol. %, greater than or equal to 52 mol. % and less than or equal to 66 mol. %, greater than or equal to 52 mol. % and less than or equal to 65 mol. %, greater than or equal to 52 mol. % and less than or equal to 64 mol. %, greater than or equal to 53 mol. % and less than or equal to 70 mol. %, greater than or equal to 53 mol. % and less than or equal to 68 mol. %, greater than or equal to 53 mol. % and less than or equal to 66 mol. %, greater than or equal to 53 mol. % and less than or equal to 65 mol. %, or greater than or equal to 53 mol. % and less than or equal to 64 mol. %, greater than or equal to 54 mol. % and less than or equal to 70 mol. %, greater than or equal to 54 mol. % and less than or equal to 68 mol. %, greater than or equal to 54 mol. % and less than or equal to 66 mol. %, greater than or equal to 54 mol. % and less than or equal to 65 mol. %, or greater than or equal to 54 mol. % and less than or equal to 64 mol. %, or any and all sub-ranges formed from these endpoints.

Like SiO₂, Al₂O₃ may also stabilize the glass network and additionally provides improved mechanical properties and chemical durability to the glass composition and the resultant colored glass article. The amount of Al₂O₃ may also be tailored to control the viscosity of the glass composition.

Accordingly, in embodiments, the glass composition and the resultant colored glass article may comprise greater than or equal to 10 mol. % and less than or equal to 20 mol. % Al₂O₃. In embodiments, the glass composition and the resultant colored glass article may comprise greater than or equal to 11 mol. % and less than or equal to 19 mol. % Al₂O₃ or greater than or equal to 14 mol. % and less than or equal to 17 mol. % Al₂O₃. In embodiments, the concentration of Al₂O₃ in the glass composition and the resultant colored glass article may be greater than or equal to 10 mol. %, greater than or equal to 11 mol. %, greater than or equal to 12 mol. %, greater than or equal to 13 mol. %, or greater than or equal to 14 mol. %. In embodiments, the concentration of Al₂O₃ in the glass composition and the resultant colored glass article may be less than or equal to 20 mol. %, less than or equal to 19 mol. %, less than or equal to 18 mol. %, less than or equal to 17 mol. %, or less than or equal to 16 mol. %. In embodiments, the concentration of Al₂O₃ in the glass composition and the resultant colored glass article may be greater than or equal to 10 mol. % and less than or equal to 20 mol. %, greater than or equal to 10 mol. % and less than or equal to 19 mol. %, greater than or equal to 10 mol. % and less than or equal to 18 mol. %, greater than or equal to 10 mol. % and less than or equal to 17 mol. %, greater than or equal to 10 mol. % and less than or equal to 16 mol. %, greater than or equal to 11 mol. % and less than or equal to 20 mol. %, greater than or equal to 11 mol. % and less than or equal to 19 mol. %, greater than or equal to 11 mol. % and less than or equal to 18 mol. %, greater than or equal to 11 mol. % and less than or equal to 17 mol. %, greater than or equal to 11 mol. % and less than or equal to 16 mol. %, greater than or equal to 12 mol. % and less than or equal to 20 mol. %, greater than or equal to 12 mol. % and less than or equal to 19 mol. %, greater than or equal to 12 mol. % and less than or equal to 18 mol. %, greater than or equal to 12 mol. % and less than or equal to 17 mol. %, greater than or equal to 12 mol. % and less than or equal to 16 mol. %, greater than or equal to 13 mol. % and less than or equal to 20 mol. %, greater than or equal to 13 mol. % and less than or equal to 19 mol. %, greater than or equal to 13 mol. % and less than or equal to 18 mol. %, greater than or equal to 13 mol. % and less than or equal to 17 mol. %, greater than or equal to 13 mol. % and less than or equal to 16 mol. %, greater than or equal to 14 mol. % and less than or equal to 20 mol. %, greater than or equal to 14 mol. % and less than or equal to 19 mol. %, greater than or equal to 14 mol. % and less than or equal to 18 mol. %, greater than or equal to 14 mol. % and less than or equal to 17 mol. %, greater than or equal to 14 mol. % and less than or equal to 16 mol. %, or any and all sub-ranges formed from any of these endpoints.

B₂O₃ decreases the melting temperature of the glass composition and may also improve the damage resistance of the resultant colored glass article. In addition, B₂O₃ is added to reduce the formation of non-bridging oxygen, the presence of which may reduce fracture toughness. The concentration of B₂O₃ should be sufficiently high (e.g., greater than or equal to 4 mol. %) to improve the formability and increase the fracture toughness of the colored glass article. However, if B₂O₃ is too high (e.g., greater than 10 mol. %), the annealing point and strain point may decrease, which increases stress relaxation and reduces the overall strength of the colored glass article.

Accordingly, in embodiments, the glass composition and the resultant colored glass article may comprise greater than or equal to 4 mol. % and less than or equal to 10 mol. % B₂O₃. In embodiments, the glass composition and the resultant colored glass article may comprise greater than or equal to 4.5 mol. % and less than or equal to 8 mol. % B₂O₃, or greater than or equal to 5 mol. % and less than or equal to 7 mol. % B₂O₃. In embodiments, the concentration of B₂O₃ in the glass composition and the resultant colored glass article may be greater than or equal to 4 mol. %, greater than or equal to 4.5 mol. %, or greater than or equal to 5 mol. %. In embodiments, the concentration of B₂O₃ in the glass composition and the resultant colored glass article may be less than or equal to 10 mol. %, less than or equal to 9 mol. %, less than or equal to 8 mol. %, or less than or equal to 7 mol. %. In embodiments, the concentration of B₂O₃ in the glass composition and the resultant colored glass article may be greater than or equal to 4 mol. % and less than or equal to 10 mol. %, greater than or equal to 4 mol. % and less than or equal to 9 mol. %, greater than or equal to 4 mol. % and less than or equal to 8 mol. %, greater than or equal to 4 mol. % and less than or equal to 7 mol. %, greater than or equal to 4.5 mol. % and less than or equal to 10 mol. %, greater than or equal to 4.5 mol. % and less than or equal to 9 mol. %, greater than or equal to 4.5 mol. % and less than or equal to 8 mol. %, greater than or equal to 4.5 mol. % and less than or equal to 7 mol. %, greater than or equal to 5 mol. % and less than or equal to 10 mol. %, greater than or equal to 5 mol. % and less than or equal to 9 mol. %, greater than or equal to 5 mol. % and less than or equal to 8 mol. %, greater than or equal to 5 mol. % and less than or equal to 7 mol. %, or any and all sub-ranges formed from any of these endpoints.

Li₂O aids in the ion-exchangeability of the colored glass article and also reduces the softening point of the glass composition, thereby increasing the formability of the colored glass articles. However, if the amount of Li₂O is too high (e.g., greater than 14 mol. %), the liquidus temperature may increase, thereby diminishing the manufacturability of the colored glass article.

Accordingly, in embodiments, the glass composition and the resultant colored glass article may comprise greater than or equal to 7 mol. % and less than or equal to 17 mol. % Li₂O. In embodiments, the glass composition and the resultant colored glass article may comprise greater than or equal to 8 mol. % and less than or equal to 16 mol. %, greater than or equal to 9 mol. % and less than or equal to 15 mol. %, greater than or equal to 10 mol. % and less than or equal to 14 mol. %, or even 11 mol. % and less than or equal to 13 mol. % Li₂O. In embodiments, the concentration of Li₂O in the glass composition and the resultant colored glass article may be greater than or equal to 8 mol. %, greater than or equal to 9 mol. %, greater than or equal to 10 mol. %, greater than or equal to 11 mol. %, greater than or equal to 11.5 mol. %, or greater than or equal to 12 mol. %. In embodiments, the concentration of Li₂O in the glass composition and the resultant colored glass article may be less than or equal to 17 mol. %, less than or equal to 16 mol. %, less than or equal to 15 mol. %, less than or equal to 14 mol. %, less than or equal to 13 mol. %, or less than or equal to 12 mol. %. In embodiments, the concentration of Li₂O in the glass composition and the resultant colored glass article may be greater than or equal to 7 mol. % and less than or equal to 16 mol. %, greater than or equal to 7 mol. % and less than or equal to 15 mol. %, greater than or equal to 7 mol. % and less than or equal to 14 mol. %, greater than or equal to 7 mol. % and less than or equal to 13 mol. %, greater than or equal to 7 mol. % and less than or equal to 12 mol. %, greater than or equal to 8 mol. % and less than or equal to 17 mol. %, greater than or equal to 8 mol. % and less than or equal to 16 mol. %, greater than or equal to 8 mol. % and less than or equal to 15 mol. %, greater than or equal to 8 mol. % and less than or equal to 14 mol. %, greater than or equal to 8 mol. % and less than or equal to 13 mol. %, greater than or equal to 8 mol. % and less than or equal to 12 mol. %, greater than or equal to 9 mol. % and less than or equal to 17 mol. %, greater than or equal to 9 mol. % and less than or equal to 16 mol. %, greater than or equal to 9 mol. % and less than or equal to 15 mol. %, greater than or equal to 9 mol. % and less than or equal to 14 mol. %, greater than or equal to 9 mol. % and less than or equal to 13 mol. %, greater than or equal to 9 mol. % and less than or equal to 12 mol. %, greater than or equal to 10 mol. % and less than or equal to 17 mol. %, greater than or equal to 10 mol. % and less than or equal to 16 mol. %, greater than or equal to 10 mol. % and less than or equal to 15 mol. %, greater than or equal to 10 mol. % and less than or equal to 14 mol. %, greater than or equal to 10 mol. % and less than or equal to 13 mol. %, greater than or equal to 10 mol. % and less than or equal to 12 mol. %, greater than or equal to 11 mol. % and less than or equal to 17 mol. %, greater than or equal to 11 mol. % and less than or equal to 16 mol. %, greater than or equal to 11 mol. % and less than or equal to 15 mol. %, greater than or equal to 11 mol. % and less than or equal to 14 mol. %, greater than or equal to 11 mol. % and less than or equal to 13 mol. %, greater than or equal to 11 mol. % and less than or equal to 12 mol. %, greater than or equal to 11.1 mol. % and less than or equal to 17 mol. %, greater than or equal to 11.1 mol. % and less than or equal to 16 mol. %, greater than or equal to 11.1 mol. % and less than or equal to 15 mol. %, greater than or equal to 11.1 mol. % and less than or equal to 14 mol. %, greater than or equal to 11.1 mol. % and less than or equal to 13 mol. %, greater than or equal to 11.1 mol. % and less than or equal to 12 mol. %, greater than or equal to 11.5 mol. % and less than or equal to 17 mol. %, greater than or equal to 11.5 mol. % and less than or equal to 16 mol. %, greater than or equal to 11.5 mol. % and less than or equal to 15 mol. %, greater than or equal to 11.5 mol. % and less than or equal to 14 mol. %, greater than or equal to 11.5 mol. % and less than or equal to 13 mol. %, greater than or equal to 11.5 mol. % and less than or equal to 12 mol. %, greater than or equal to 12 mol. % and less than or equal to 17 mol. %, greater than or equal to 12 mol. % and less than or equal to 16 mol. %, greater than or equal to 12 mol. % and less than or equal to 15 mol. %, greater than or equal to 12 mol. % and less than or equal to 14 mol. %, greater than or equal to 12 mol. % and less than or equal to 13 mol. %, greater than or equal to 13 mol. % and less than or equal to 17 mol. %, greater than or equal to 13 mol. % and less than or equal to 16 mol. %, greater than or equal to 13 mol. % and less than or equal to 15 mol. %, greater than or equal to 13 mol. % and less than or equal to 14 mol. %, or any and all sub-ranges formed from any of these endpoints.

Na₂O decreases the melting point and improves formability of the colored glass article. Na₂O, together with Li₂O, aids in maintaining a relatively low liquidus viscosity which may improve formability. However, if too much Na₂O is added to the glass composition, the melting point may be too low.

Accordingly, in embodiments, the glass composition and the resultant colored glass article may comprise greater than or equal to 1 mol. % and less than or equal to 9 mol. % Na₂O. In embodiments, the glass composition and the resultant colored glass article may comprise greater than or equal to 1.5 mol. % and less than or equal to 9 mol. % Na₂O, greater than or equal to 2 mol. % and less than or equal to 9 mol. % Na₂O, greater than or equal to 2.5 mol. % and less than or equal to 9 mol. % Na₂O, greater than or equal to 3 mol. % and less than or equal to 8.5 mol. % Na₂O, greater than or equal to 3.5 mol. % and less than or equal to 8 mol. % Na₂O, or greater than or equal to 4 mol. % and less than or equal to 7 mol. % Na₂O. In embodiments, the concentration of Na₂O in the glass composition and the resultant colored glass article may be greater than or equal to 1.5 mol. %, greater than or equal to 2.0 mol. %, greater than or equal to 2.5 mol. %, greater than or equal to 3 mol. %, greater than or equal to 3.5 mol. %, or greater than or equal to 4 mol. %. In embodiments, the concentration of Na₂O in the glass composition and the resultant colored glass article may be less than or equal to 9 mol. %, less than or equal to 8.5 mol. %, less than or equal to 8 mol. %, less than or equal to 7 mol. %, or less than or equal to 6 mol. %. In embodiments, the concentration of Na₂O in the glass composition and the resultant colored glass article may be greater than or equal to 1 mol. % and less than or equal to 9 mol. %, greater than or equal to 1 mol. % and less than or equal to 8 mol. %, greater than or equal to 1 mol. % and less than or equal to 7 mol. %, greater than or equal to 1 mol. % and less than or equal to 6 mol. %, greater than or equal to 1.5 mol. % and less than or equal to 9 mol. %, greater than or equal to 1.5 mol. % and less than or equal to 8 mol. %, greater than or equal to 1.5 mol. % and less than or equal to 7 mol. %, greater than or equal to 1.5 mol. % and less than or equal to 6 mol. %, greater than or equal to 2 mol. % and less than or equal to 9 mol. %, greater than or equal to 2 mol. % and less than or equal to 8 mol. %, greater than or equal to 2 mol. % and less than or equal to 7 mol. %, greater than or equal to 2 mol. % and less than or equal to 6 mol. %, greater than or equal to 2.5 mol. % and less than or equal to 9 mol. %, greater than or equal to 2.5 mol. % and less than or equal to 8 mol. %, greater than or equal to 2.5 mol. % and less than or equal to 7 mol. %, greater than or equal to 2.5 mol. % and less than or equal to 6 mol. %, greater than or equal to 3 mol. % and less than or equal to 9 mol. %, greater than or equal to 3 mol. % and less than or equal to 8 mol. %, greater than or equal to 3 mol. % and less than or equal to 7 mol. %, greater than or equal to 3 mol. % and less than or equal to 6 mol. %, greater than or equal to 3.5 mol. % and less than or equal to 9 mol. %, greater than or equal to 3.5 mol. % and less than or equal to 8 mol. %, greater than or equal to 3.5 mol. % and less than or equal to 7 mol. %, greater than or equal to 3.5 mol. % and less than or equal to 6 mol. %, greater than or equal to 4 mol. % and less than or equal to 9 mol. %, greater than or equal to 4 mol. % and less than or equal to 8 mol. %, greater than or equal to 4 mol. % and less than or equal to 7 mol. %, greater than or equal to 4 mol. % and less than or equal to 6 mol. %, or any and all sub-ranges formed from any of these endpoints.

The glass compositions and the resultant colored glass articles may further comprise alkali metal oxides other than Li₂O and Na₂O, such as K₂O. K₂O, when included, promotes ion-exchange and may increase the depth of compression and decrease the melting point to improve the formability of the colored glass article. However, adding too much K₂O may cause the surface compressive stress and melting point to be too low.

Accordingly, in embodiments, the amount of K₂O added to the glass composition may be limited. In embodiments, the glass composition and the resultant colored glass article may comprise greater than or equal to 0 mol. % and less than or equal to 1 mol. % K₂O, greater than or equal to 0.2 mol. % and less than or equal to 1 mol. % K₂O, greater than or equal to 0 mol. % and less than or equal to 0.5 mol. % K₂O, or greater than or equal to 0 mol. % and less than or equal to 0.25 mol. % K₂O. In embodiments, the concentration of K₂O in the glass composition and the resultant colored glass article may be greater than or equal to 0 mol. %, greater than or equal to 0.2 mol. %, greater than or equal to 0.25 mol. %, or even greater than or equal to 0.5 mol. %. In embodiments, the concentration of K₂O in the glass composition and the resultant colored glass article may be less than or equal to 1 mol. %, less than or equal to 0.5 mol. %, or less than or equal to 0.25 mol. %. In embodiments, the concentration of K₂O in the glass composition and the resultant colored glass article may be greater than or equal to 0 mol. % and less than or equal to 1 mol. %, greater than or equal to 0 mol. % and less than or equal to 0.5 mol. %, greater than or equal to 0 mol. % and less than or equal to 0.25 mol. %, greater than or equal to 0.2 mol. % and less than or equal to 1 mol. %, greater than or equal to 0.2 mol. % and less than or equal to 0.5 mol. %, greater than or equal to 0.25 mol. % and less than or equal to 1 mol. %, greater than or equal to 0.25 mol. % and less than or equal to 0.5 mol. %, greater than or equal to 0.5 mol. % and less than or equal to 1 mol. %, or any and all sub-ranges formed from any of these endpoints.

The sum of all alkali metal oxides is expressed as R₂O. Specifically, R₂O is the sum (in mol. %) of Li₂O, Na₂O, and K₂O present in the glass composition and the resultant colored glass article (i.e., R₂O═Li₂O (mol. %)+Na₂O (mol. %)+K₂O (mol. %). Like B₂O₃, the alkali oxides aid in decreasing the softening point and molding temperature of the glass composition, thereby offsetting the increase in the softening point and molding temperature of the glass composition due to higher amounts of SiO₂ in the glass composition, for example. The softening point and molding temperature may be further reduced by including combinations of alkali oxides (e.g., two or more alkali oxides) in the glass composition, a phenomenon referred to as the “mixed alkali effect.” However, it has been found that if the amount of alkali oxide is too high, the average coefficient of thermal expansion of the glass composition increases to potentially undesirable levels.

In embodiments, the concentration of R₂O in the glass compositions and the resultant colored glass articles is greater than the concentration of Al₂O₃. In embodiments, the difference between the concentrations of R₂O and Al₂O₃ (i.e., R₂O—Al₂O₃) in the glass composition and the resultant colored glass article may be greater than or equal to 0.2 mol. % and less than or equal to 5 mol. %, greater than or equal to 0.2 mol. % and less than or equal to 4.5 mol. %, or greater than or equal to 0.5 mol. % and less than or equal to 4.5 mol. %. In embodiments, the difference between the concentrations of R₂O and Al₂O₃ in the glass composition and the resultant colored glass article may be greater than or equal to 0.2 mol. %, greater than or equal to 0.5 mol. %, greater than or equal to 1 mol. %, greater than or equal to 1.5 mol. %, or even greater than or equal to 2 mol. %. In embodiments, the difference between the concentrations of R₂O and Al₂O₃ in the glass composition and the resultant colored glass article may be less than or equal to 5 mol. %, less than or equal to 4.5 mol. %, or less than or equal to 4 mol. %, or less than or equal to 3 mol. %. In embodiments, the difference between the concentrations of R₂O and Al₂O₃ in the glass composition and the resultant colored glass article may be greater than or equal to 0.2 mol. % and less than or equal to 5 mol. %, greater than or equal to 0.2 mol. % and less than or equal to 4.5 mol. %, greater than or equal to 0.2 mol. % and less than or equal to 4 mol. %, greater than or equal to 0.2 mol. % and less than or equal to 3.5 mol. %, greater than or equal to 0.2 mol. % and less than or equal to 3 mol. %, greater than or equal to 0.5 mol. % and less than or equal to 5 mol. %, greater than or equal to 0.5 mol. % and less than or equal to 4.5 mol. %, greater than or equal to 0.5 mol. % and less than or equal to 4 mol. %, greater than or equal to 0.5 mol. % and less than or equal to 3.5 mol. %, greater than or equal to 0.5 mol. % and less than or equal to 3 mol. %, greater than or equal to 1 mol. % and less than or equal to 5 mol. %, greater than or equal to 1 mol. % and less than or equal to 4.5 mol. %, greater than or equal to 1 mol. % and less than or equal to 4 mol. %, greater than or equal to 1 mol. % and less than or equal to 3.5 mol. %, greater than or equal to 1 mol. % and less than or equal to 3 mol. %, greater than or equal to 1.5 mol. % and less than or equal to 5 mol. %, greater than or equal to 1.5 mol. % and less than or equal to 4.5 mol. %, greater than or equal to 1.5 mol. % and less than or equal to 4 mol. %, greater than or equal to 1.5 mol. % and less than or equal to 3.5 mol. %, greater than or equal to 1.5 mol. % and less than or equal to 3 mol. %, greater than or equal to 2 mol. % and less than or equal to 5 mol. %, greater than or equal to 2 mol. % and less than or equal to 4.5 mol. %, greater than or equal to 2 mol. % and less than or equal to 4 mol. %, greater than or equal to 2 mol. % and less than or equal to 3.5 mol. %, greater than or equal to 2 mol. % and less than or equal to 3 mol. %, or any and all sub-ranges formed from any of these endpoints.

It has been found that excess R₂O content (relative to Al₂O₃) has a significant effect on the shape of silver particles precipitated in the glass, which particles are responsible for color generation within the colored glass articles of the present disclosure. When the difference between the concentrations of R₂O and Al₂O₃ in the glass composition and the resultant colored glass article is zero, or a small positive value (e.g., ≤0.2), the silver generally remains bound in the glass network as a 1V cation, irrespective of heat treatment time and temperature. This is attributed to the fact that the glass network is more highly polymerized. As the concentration of excess alkali is increased (e.g., R₂O—Al₂O₃>0.2), the glass matrix becomes more depolymerized, allowing the silver to more readily leave the glass network and be reduced by the SnO₂ present in the glass network to form anisotropic metallic particles in the glass during thermal treatment. As the excess alkali increases (i.e., the value of R₂O—Al₂O₃ increases), the silver more readily leaves the glass network during annealing and/or heat treatment of the glass and it becomes difficult to control precipitation during heat treatment. For example, once the value of R₂O—Al₂O₃ exceeds 5 mol. %, it is difficult to control the precipitation of silver ions in the glass and, therefore, becomes difficult to attain specific colors. Further, the range of colors that these R₂O-rich glass compositions can produce is more limited due to the formation of a larger number of small isotropic silver particles. Excess alkali concentration may also have an effect on the stability of the glass composition, which may affect its propensity to phase separate and/or crystallize during cooling and post-forming heat treatment.

SnO₂ acts as a fining agent. That is, SnO₂ facilitates the removal of bubbles from the glass composition during the formation of the colored glass article. SnO₂ also aids in the reduction of silver in the glass leading to the formation of silver particles in the glass.

Accordingly, in embodiments, the glass composition and the resultant colored glass article may comprise greater than or equal to 0.01 mol. % and less than or equal to 1 mol. % SnO₂. In embodiments, the glass composition and the resultant colored glass article may comprise greater than or equal to 0.05 mol. % and less than or equal to 0.5 mol. % SnO₂, or greater than or equal to 0.1 mol. % and less than or equal to 0.25 mol. % SnO₂. In embodiments, the concentration of SnO₂ in the glass composition and the resultant colored glass article may be greater than or equal to 0.01 mol. %, greater than or equal to 0.05 mol. %, or greater than or equal to 0.1 mol. %. In embodiments, the concentration of SnO₂ in the glass composition and the resultant colored glass article may be less than or equal to 1 mol. %, less than or equal to 0.75 mol. %, less than or equal to 0.5 mol. %, or less than or equal to 0.25 mol. %. In embodiments, the concentration of SnO₂ in the glass composition and the resultant colored glass article may be greater than or equal to 0.01 mol. % and less than or equal to 1 mol. %, greater than or equal to 0.01 mol. % and less than or equal to 0.75 mol. %, greater than or equal to 0.01 mol. % and less than or equal to 0.5 mol. %, greater than or equal to 0.01 mol. % and less than or equal to 0.25 mol. %, greater than or equal to 0.05 mol. % and less than or equal to 1 mol. %, greater than or equal to 0.05 mol. % and less than or equal to 0.75 mol. %, greater than or equal to 0.05 mol. % and less than or equal to 0.5 mol. %, greater than or equal to 0.05 mol. % and less than or equal to 0.25 mol. %, greater than or equal to 0.1 mol. % and less than or equal to 1 mol. %, greater than or equal to 0.1 mol. % and less than or equal to 0.75 mol. %, greater than or equal to 0.1 mol. % and less than or equal to 0.5 mol. %, greater than or equal to 0.1 mol. % and less than or equal to 0.25 mol. %, or any and all sub-ranges formed from any of these endpoints.

Ag acts as a colorant in the glass composition. That is, the color of the colored glass article is generated by the presence of silver particles in the colored glass article that are formed from the reduction silver ions in the glass composition.

Accordingly, in embodiments, the glass composition and the resultant colored glass article may comprise greater than or equal to 0.01 mol. % and less than or equal to 5 mol. % Ag. In embodiments, the glass composition and the resultant colored glass article may comprise greater than or equal to 0.05 mol. % and less than or equal to 2.5 mol. % Ag, greater than or equal to 0.1 mol. % and less than or equal to 1 mol. % Ag, greater than or equal to 0.1 mol. % and less than or equal to 0.75 mol. % Ag, greater than or equal to 0.1 mol. % and less than or equal to 0.5 mol. % Ag, or greater than or equal to 0.1 mol. % and less than or equal to 0.25 mol. % Ag. In embodiments, the concentration of Ag in the glass composition and the resultant colored glass article may be greater than or equal to 0.01 mol. %, greater than or equal to 0.05 mol. %, or greater than or equal to 0.1 mol. %. In embodiments, the concentration of Ag in the glass composition and the resultant colored glass article may be less than or equal to 5 mol. %, less than or equal to 2.5 mol. %, less than or equal to 1 mol. %, less than or equal to 0.75 mol. %, less than or equal to 0.5 mol. %, or less than or equal to 0.25 mol. %. In embodiments, the concentration of Ag in the glass composition and the resultant colored glass article may be greater than or equal to 0.01 mol. % and less than or equal to 5 mol. %, greater than or equal to 0.01 mol. % and less than or equal to 2.5 mol. %, greater than or equal to 0.01 mol. % and less than or equal to 1 mol. %, greater than or equal to 0.01 mol. % and less than or equal to 0.75 mol. %, greater than or equal to 0.01 mol. % and less than or equal to 0.5 mol. %, greater than or equal to 0.01 mol. % and less than or equal to 0.5 mol. %, greater than or equal to 0.05 mol. % and less than or equal to 5 mol. %, greater than or equal to 0.05 mol. % and less than or equal to 2.5 mol. %, greater than or equal to 0.05 mol. % and less than or equal to 1 mol. %, greater than or equal to 0.05 mol. % and less than or equal to 0.75 mol. %, greater than or equal to 0.05 mol. % and less than or equal to 0.5 mol. %, greater than or equal to 0.05 mol. % and less than or equal to 0.25 mol. %, greater than or equal to 0.1 mol. % and less than or equal to 5 mol. %, greater than or equal to 0.1 mol. % and less than or equal to 2.5 mol. %, greater than or equal to 0.1 mol. % and less than or equal to 1 mol. %, greater than or equal to 0.1 mol. % and less than or equal to 0.75 mol. %, greater than or equal to 0.1 mol. % and less than or equal to 0.5 mol. %, greater than or equal to 0.1 mol. % and less than or equal to 0.25 mol. %, or any and all sub-ranges formed from any of these endpoints.

Conventionally, halide-free colored glass articles that comprise silver in as-formed condition (i.e., colored glass articles that have not been subjected to mechanical stretching) produce only yellow, orange, and red colors upon a suitable heat treatment applied to the glass article in as-formed condition. These colors are generated by the formation of isotropic (i.e., nominally spherical) silver particles in the conventional, halide-free colored glass article. These isotropic silver particles support a single localized surface plasmon resonance. Isotropic silver particles are the most energetically favorably to form because they have the lowest surface area to volume ratio and, as a result, they are the most common geometry observed in colored glass articles that comprise silver.

In contrast, colored glass articles that comprise anisotropic silver particles can produce a much broader range of colors, such as pink, purple, blue, green, brown and black. As used herein, anisotropic silver particles refer to silver particles having an aspect ratio greater than 1, where the aspect ratio is the ratio of longest dimension of the particle to the shortest dimension of the particle (e.g., a ratio of the length of the particle to the width of the particle is greater than 1). This is in contrast to an isotropic silver particle in which the aspect ratio is 1. The broader color gamut produced in glasses having anisotropic silver particles is because anisotropic silver particles support two distinct plasmonic modes: a higher energy transverse mode, and a lower energy longitudinal mode. These two distinct plasmonic modes can be observed via absorption spectra of the colored glass articles, which typically have at least two distinct peaks when anisotropic silver particles are present in the glass. By varying the aspect ratio of anisotropic particles, the resonant absorption of these two plasmonic modes can be tuned and, as a result, the color shifted.

Conventionally, the formation of anisotropic metallic particles in glass can be either induced by elongating spherical particles of silver through shear forces (e.g., by stretching the colored glass article via re-draw) using mechanical stretching processes. The mechanical stretching process results in a glass article having silver particles that are generally aligned in parallel with one another along the stretching direction (i.e., the glass is polarized).

A conventional alternative to mechanical stretching processes for creating anisotropic metallic particles in a glass article is the incorporation of halides (e.g., F, Cl, and Br) in the glass composition. In halide-containing colored glass articles, anisotropic silver particles are formed by templating the particles on elongated and/or pyramidal-shaped halide crystals. As noted previously, the inclusion of halides in the glass composition may be undesirable.

In contrast, the colored glass article of the present disclosure may generate abroad range of colors, such as yellow, orange, red, green, pink, purple, brown, and black without the inclusion of halides in the glass composition or the use of mechanical stretching processes. Without being bound by any particular theory, it is believed that anisotropic silver particles may form in the colored glass articles of the present disclosure due to a mechanism similar to the template growth caused by the inclusion of halides in the glass composition. However, instead of templating on a halide-containing crystal, silver may form on nano-sized crystals of spodumene, lithium silicate, and/or beta quartz during heat treatment of the glass article in its as formed condition. Additionally and/or alternatively, it is believed that anisotropic silver particles may precipitate at the interfaces between phase separated regions of the colored glass article and/or regions that are only partially crystalized. Further, these crystals and/or phase separated regions may form a nucleation site for the growth of anisotropic silver particles.

Accordingly, in embodiments, the glass composition and the resultant colored glass article may be substantially free of halides. As used in the present disclosure, the term “substantially free” of a component means the glass composition and the resultant colored glass article comprise less than 100 parts per million (ppm) of the component. For example, the glass composition and the resultant colored glass article may comprise less than 100 ppm halides, such as less than 50 ppm halides, less than 25 ppm halides, less than 10 ppm halides, or even 0 ppm halides.

As noted previously, colored glass articles produced using mechanical stretching processes generally include anisotropic silver particles similar to those of the colored glass article of the present application. However, it should be noted that these mechanical stretching processes also result in the anisotropic silver particles being ordered and aligned (e.g., the longer dimensions of each anisotropic silver particles are facing in the same direction, such as in the direction of mechanical stretching). Put more simply, the colored glass articles produced using mechanical stretching processes are polarized due to the alignment of the anisotropic silver particles in the glass as a result of mechanical stretching.

In contrast, in the embodiments described herein, the colored glass articles of the present disclosure, which are not subjected to mechanical stretching processes, are non-polarized. In embodiments, the anisotropic silver particles of the colored glass article are not aligned (e.g., the longer dimensions of two or more anisotropic silver particles are facing in different directions) and, instead, the anisotropic silver particles are randomly aligned in the glass.

In embodiments, the anisotropic silver particles in the colored glass articles described herein have a length greater than or equal to 10 nm, greater than or equal to 12 nm, greater than or equal to 14 nm, greater than or equal to 16 nm, greater than or equal to 18 nm, greater than or equal to 10 nm, greater than or equal to 22 nm, greater than or equal to 24 nm, greater than or equal to 26 nm, greater than or equal to 28 nm, greater than or equal to 30 nm, greater than or equal to 32 nm, greater than or equal to 34 nm, greater than or equal to 36 nm, or even greater than or equal to 38 nm. The length of the anisotropic silver particles may be measured using image analysis on electron micrographs obtained from samples of the colored glass articles using software such as ImageJ software. To obtain the length and width of the anisotropic silver particles, a calibration is set by measuring the scale bar on the electron micrograph, converting each pixel to the appropriate unit length. The image is then converted into a grayscale image. A software measuring tool is then used to measure the number of pixels from one end to the other of each particle as well as the number of pixels across the greatest width of the particle. In embodiments an automated script is run to measure the length and aspect ratios of multiple particles automatically. In embodiments, the anisotropic silver particles in the colored glass articles described herein have a length less than or equal to 40 nm, less than or equal to 38 nm, less than or equal to 36 nm, less than or equal to 34 nm, less than or equal to 32 nm, less than or equal to 30 nm, less than or equal to 28 nm, less than or equal to 26 nm, less than or equal to 24 nm, less than or equal to 22 nm, or even less than or equal to 20 nm. In embodiments, the anisotropic silver particles in the colored glass articles described herein have a length greater than or equal to 10 nm and less than or equal to 40 nm, greater than or equal to 12 nm and less than or equal to 36 nm, greater than or equal to 14 nm and less than or equal to 34 nm, greater than or equal to 14 nm and less than or equal to 32 nm, greater than or equal to 14 nm and less than or equal to 28 nm, greater than or equal to 14 nm and less than or equal to 26 nm, greater than or equal to 16 nm and less than or equal to 26 nm, greater than or equal to 16 nm and less than or equal to 24 nm, greater than or equal to 16 nm and less than or equal to 22 nm, greater than or equal to 16 nm and less than or equal to 20 nm, or any and all sub-ranges formed from any of these endpoints.

In embodiments, the anisotropic silver particles in the colored glass articles described herein have a width greater than or equal to 6 nm, greater than or equal to 8 nm, greater than or equal to 10 nm, greater than or equal to 12 nm, or even greater than or equal to 14 nm. In embodiments, the anisotropic silver particles in the colored glass articles described herein have a width less than or equal to 20 nm, less than or equal to 18 nm, less than or equal to 16 nm, less than or equal to 12 nm, or even less than or equal to 10 nm. In embodiments, the anisotropic silver particles in the colored glass articles described herein have a width greater than or equal to 6 nm and less than or equal to 20 nm, greater than or equal to 6 nm and less than or equal to 18 nm, greater than or equal to 6 nm and less than or equal to 16 nm, greater than or equal to 8 nm and less than or equal to 20 nm, greater than or equal to 8 nm and less than or equal to 18 nm, greater than or equal to 8 nm and less than or equal to 16 nm, greater than or equal to 10 nm and less than or equal to 20 nm, greater than or equal to 10 nm and less than or equal to 18 nm, greater than or equal to 10 nm and less than or equal to 16 nm, greater than or equal to 10 nm and less than or equal to 14 nm, or any and all sub-ranges formed from any of these endpoints.

In embodiments, the anisotropic silver particles in the colored glass articles described herein have an aspect ratio (i.e., the ratio of the length to the width of the anisotropic silver nanoparticles) greater than 1, greater than or equal to 1.5, greater than or equal to 2, or even greater than or equal to 2.5. In embodiments, the anisotropic silver particles in the colored glass articles described herein have an aspect ratio less than or equal to 3, less than or equal to 2.5, less than or equal to 2, or even less than or equal to 1.5. In embodiments, the anisotropic silver particles in the colored glass articles described herein have an aspect ratio greater than 1 and less than or equal to 3, greater than 1 and less than or equal to 2.5, greater than 1 and less than or equal to 2, greater than 1 and less than or equal to 1.5, greater than or equal to 1.5 and less than or equal to 3, greater than or equal to 1.5 and less than or equal to 2.5, greater than or equal to 1.5 and less than or equal to 2, greater than or equal to 2 and less than or equal to 3, greater than or equal to 2 and less than or equal to 2.5, or any and all sub-ranges formed from any of these endpoints.

The glass compositions and the resultant colored glass articles may further comprise one or more rare-earth oxides, such as CeO₂, Nd₂O₃, Er₂O₃. Rare-earth oxides may be added to provide additional visible light absorbance to the glass (in addition to that imparted by the silver) to further alter the color of the glass. Rare-earth oxides may also be added to increase the Young's modulus and/or the annealing point of the resultant glass.

In embodiments, the glass composition and the resultant colored glass article may comprise greater than or equal to 0 mol. % and less than or equal to 4 mol. % of CeO₂, In embodiments, the glass composition and the resultant colored glass article may comprise greater than or equal to 0 mol. % and less than or equal to 3 mol. % CeO₂, greater than or equal to 0 mol. % and less than or equal to 1 mol. % of CeO₂, greater than or equal to 0.05 mol. % and less than or equal to 1 mol. % of CeO₂, or greater than or equal to 0.05 mol. % and less than or equal to 0.5 mol. % of CeO₂. In embodiments, the concentration of CeO₂ in the glass composition and the resultant colored glass article may be greater than or equal to 0 mol. %, or even greater than or equal to 0.05 mol. %. In embodiments, the concentration of CeO₂ in the glass composition and the resultant colored glass article may be less than or equal to 4 mol. %, less than or equal to 3 mol. %, less than or equal to 2 mol. %, less than or equal to 1 mol. % or less than or equal to 0.5 mol. %. In embodiments, the concentration of one or more of CeO₂ in the glass composition and the resultant colored glass article may be greater than or equal to 0 mol. % and less than or equal to 4 mol. %, greater than or equal to 0 mol. % and less than or equal to 3 mol. %, greater than or equal to 0 mol. % and less than or equal to 2 mol. %, greater than or equal to 0 mol. % and less than or equal to 1 mol. %, greater than or equal to 0 mol. % and less than or equal to 0.5 mol. %, greater than or equal to 0.05 mol. % and less than or equal to 4 mol. %, greater than or equal to 0.05 mol. % and less than or equal to 3 mol. %, greater than or equal to 0.05 mol. % and less than or equal to 2 mol. %, greater than or equal to 0.05 mol. % and less than or equal to 1 mol. %, or even greater than or equal to 0.05 mol. % and less than or equal to 0.5 mol. %, or any and all sub-ranges formed from any of these endpoints.

In embodiments, the glass composition and the resultant colored glass article may comprise greater than or equal to 0 mol. % and less than or equal to 4 mol. % of Nd₂O₃, In embodiments, the glass composition and the resultant colored glass article may comprise greater than or equal to 0 mol. % and less than or equal to 3 mol. % Nd₂O₃, greater than or equal to 0 mol. % and less than or equal to 1 mol. % of Nd₂O₃, greater than or equal to 0 mol. % and less than or equal to 1 mol. % of Nd₂O₃, greater than or equal to 0.1 mol. % and less than or equal to 1 mol. % of Nd₂O₃, greater than or equal to 0.1 mol. % and less than or equal to 1.5 mol. % of Nd₂O₃, or greater than or equal to 0.1 mol. % and less than or equal to 0.5 mol. % of Nd₂O₃. In embodiments, the concentration of Nd₂O₃ in the glass composition and the resultant colored glass article may be greater than or equal to 0 mol. %, or even greater than or equal to 0.1 mol. %. In embodiments, the concentration of Nd₂O₃ in the glass composition and the resultant colored glass article may be less than or equal to 4 mol. %, less than or equal to 3 mol. %, less than or equal to 2 mol. %, less than or equal to 1 mol. % or less than or equal to 0.5 mol. %. In embodiments, the concentration of one or more of Nd₂O₃ in the glass composition and the resultant colored glass article may be greater than or equal to 0 mol. % and less than or equal to 4 mol. %, greater than or equal to 0 mol. % and less than or equal to 3 mol. %, greater than or equal to 0 mol. % and less than or equal to 2 mol. %, greater than or equal to 0 mol. % and less than or equal to 1 mol. %, greater than or equal to 0 mol. % and less than or equal to 1.5 mol. %, greater than or equal to 0 mol. % and less than or equal to 0.5 mol. %, greater than or equal to 0.1 mol. % and less than or equal to 4 mol. %, greater than or equal to 0.1 mol. % and less than or equal to 3 mol. %, greater than or equal to 0.1 mol. % and less than or equal to 2 mol. %, greater than or equal to 0.1 mol. % and less than or equal to 1.5 mol. %, greater than or equal to 0.1 mol. % and less than or equal to 1 mol. %, or even greater than or equal to 0.1 mol. % and less than or equal to 0.5 mol. %, or any and all sub-ranges formed from any of these endpoints.

In embodiments, the glass composition and the resultant colored glass article may comprise greater than or equal to 0 mol. % and less than or equal to 4 mol. % of Er₂O₃, In embodiments, the glass composition and the resultant colored glass article may comprise greater than or equal to 0 mol. % and less than or equal to 3 mol. % Er₂O₃, greater than or equal to 0 mol. % and less than or equal to 1.5 mol. % of Er₂O₃, greater than or equal to 0 mol. % and less than or equal to 1 mol. % of Er₂O₃, greater than or equal to 0.1 mol. % and less than or equal to 1.5 mol. % of Er₂O₃, greater than or equal to 0.1 mol. % and less than or equal to 1 mol. % of Er₂O₃, or greater than or equal to 0.1 mol. % and less than or equal to 0.5 mol. % of Er₂O₃. In embodiments, the concentration of Er₂O₃ in the glass composition and the resultant colored glass article may be greater than or equal to 0 mol. %, or even greater than or equal to 0.1 mol. %. In embodiments, the concentration of Er₂O₃ in the glass composition and the resultant colored glass article may be less than or equal to 4 mol. %, less than or equal to 3 mol. %, less than or equal to 2 mol. %, less than or equal to 1 mol. % or less than or equal to 0.5 mol. %. In embodiments, the concentration of one or more of Er₂O₃ in the glass composition and the resultant colored glass article may be greater than or equal to 0 mol. % and less than or equal to 4 mol. %, greater than or equal to 0 mol. % and less than or equal to 3 mol. %, greater than or equal to 0 mol. % and less than or equal to 2 mol. %, greater than or equal to 0 mol. % and less than or equal to 1.5 mol. %, greater than or equal to 0 mol. % and less than or equal to 1 mol. %, greater than or equal to 0 mol. % and less than or equal to 0.5 mol. %, greater than or equal to 0.1 mol. % and less than or equal to 4 mol. %, greater than or equal to 0.1 mol. % and less than or equal to 3 mol. %, greater than or equal to 0.1 mol. % and less than or equal to 2 mol. %, greater than or equal to 0.1 mol. % and less than or equal to 1.5 mol. %, greater than or equal to 0.1 mol. % and less than or equal to 1 mol. %, or even greater than or equal to 0.1 mol. % and less than or equal to 0.5 mol. %, or any and all sub-ranges formed from any of these endpoints.

In embodiments, the colored glass articles described herein may be formed by first melting a glass composition comprising a combination of constituent glass components as described herein. Thereafter, the molten glass is formed into a precursor glass article using conventional forming techniques and, thereafter, cooled. The precursor glass article may take on any number of forms including, without limitation, sheets, tubes, rods, containers (e.g., vials, bottles, jars, etc.) or the like. Thereafter, the precursor glass article may be exposed to a heat treatment to induce the precipitation of randomly oriented, anisotropic silver particles in the precursor glass article thereby forming a colored glass article. The time and/or temperature of the heat treatment may be specifically selected to produce a colored glass article having a desired color. The desired color is a result of the morphology of the anisotropic silver particles precipitated in the glass which, in turn, is dependent on the time and/or temperature of the heat treatment. Accordingly, it should be understood that a single glass composition can be used to form colored glass articles having different colors based on the time and/or temperature of the applied heat treatment.

According to embodiments, the heat treatment temperature may be from about 500° C. to less than about 700° C. The heat treatment time may be from about 10 minutes to about 360 minutes.

In embodiments, colored glass articles having a yellow color may be formed by heat treating the precursor glass article at a heat treatment temperature from about 565° C. to about 600° C. for a heat treatment time from about 30 minutes to about 240 minutes.

In embodiments, colored glass articles having an orange color may be formed by heat treating the precursor glass article at a heat treatment temperature from about 590° C. to about 610° C. for a heat treatment time from about 45 minutes to about 180 minutes.

In embodiments, colored glass articles having a red color may be formed by heat treating the precursor glass article at a heat treatment temperature from about 600° C. to about 615° C. for a heat treatment time from about 180 minutes to about 300 minutes.

In embodiments, colored glass articles having a green color may be formed by heat treating the precursor glass article at a heat treatment temperature from about 620° C. to about 640° C. for a heat treatment time from about 20 minutes to about 40 minutes.

In embodiments, colored glass articles having a brown color may be formed by heat treating the precursor glass article at a heat treatment temperature from about 640° C. to about 660° C. for a heat treatment time from about 30 minutes to about 90 minutes.

In embodiments, colored glass articles having a purple color may be formed by heat treating the precursor glass article at a heat treatment temperature from about 625° C. to about 650° C. for a heat treatment time from about 30 minutes to about 90 minutes.

Unlike glass ceramics, the colored glass articles described herein do not require a separate low temperature nucleation step to facilitate the precipitation of anisotropic silver particles in the glass. Accordingly, the precursor glass articles can be plunged into a pre-heated furnace or ramped from room temperature at any rate (e.g., 1° C. per minute to 50° C. per minute) and held at a specific heat treatment temperature for a period of time. Similarly, cooling rate does not impact the resultant color and, as such, the colored glass articles can be cooled over a wide range of cooling rates.

In the embodiments described herein the colored glass articles have an average CTE of less than about 85×10⁻⁷C⁻¹, less than about 80×10⁻⁷C⁻¹, less than about 75×10⁻⁷C⁻¹, less than about 70×10⁻⁷C⁻¹, less than about 65×10⁻⁷C⁻¹, or even less than about 60×10⁻⁷C⁻¹. These relatively low CTE values improve the survivability of the glass to thermal cycling or thermal stress conditions relative to articles with higher CTEs.

The colored glass articles described herein may generally have a strain point greater than or equal to about 400° C. and less than or equal to about 550° C.

The colored glass articles described herein may also have an anneal point greater than or equal to about 450° C. and less than or equal to about 650° C.

The colored glass articles described herein may generally have a softening point greater than or equal to about 700° C. and less than or equal to about 900° C.

In embodiments, the colored glass articles described herein may have a transmitted color coordinate in the CIELAB color space, as measured at an article thickness of 1.4 mm under F2 illumination and a 100 standard observer angle, of L* greater than or equal to 0 and less than or equal to 100, a* greater than or equal to −11.12 and less than or equal to 60, and b* greater than or equal to −20 and less than or equal to 120.

In embodiments, the transmitted color coordinates of the CIELAB color space may be described in terms of a range of L* values and a region of the a* (horizontal axis or x-axis) and b* (vertical axis or y-axis) color space. The region of the a* vs. b* color space may be defined by the intersection of a plurality of lines defined by a* and b*.

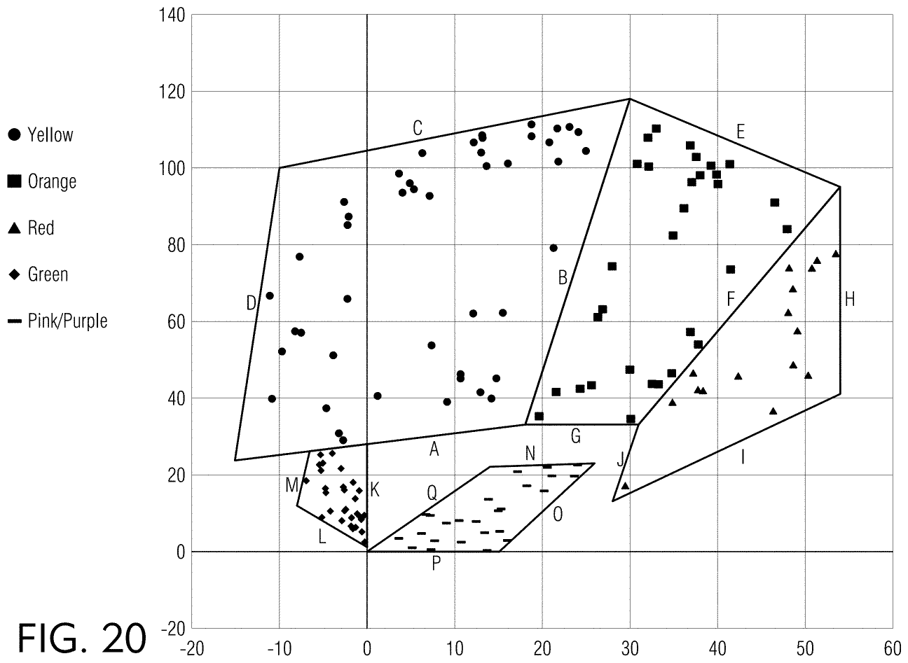

For example, in embodiments, colored glass articles that appear yellow in color may have a transmitted color coordinate in the CIELAB color space, as measured at an article thickness of 0.5 mm-1.4 mm under F2 illumination and a 10° standard observer angle, of L* greater than or equal to 20 and less than or equal to 90 and a* and b* values within a region of the a* vs. b* color space bound by the intersection of the lines: b*=0.2879·a*+27.818; b*=7.0833·a*−94.5; b*=0.45·a*+104.5; and b*=15.3·a*+253. This region is graphically depicted in FIG. 20 as the region being bound by lines A, B, C, and D.

In embodiments, colored glass articles that appear orange in color may have a transmitted color coordinate in the CIELAB color space, as measured at an article thickness of 0.5 mm-1.4 mm under F2 illumination and a 10° standard observer angle, of L* greater than or equal to 20 and less than or equal to 90 and a* and b* values within a region of the a* vs. b* color space bound by the intersection of the lines: b*=7.0833·a*−94.5; b*=−0.9583·a*+146.75; b*=2.6957·a*−50.565; and b*=33. This region is graphically depicted in FIG. 20 as the region being bound by lines B, E, F and G.

In embodiments, colored glass articles that appear red in color may have a transmitted color coordinate in the CIELAB color space, as measured as measured at an article thickness of 0.5 mm-1.4 mm under F2 illumination and a 100 standard observer angle, of L* greater than or equal to 20 and less than or equal to 90 and a* and b* values within a region of the a* vs. b* color space bound by the intersection of the lines: b*=2.6957·a*−50.565; a*=54; b*=1.0769·a*−17.154; and b*=6.6667·a*−173.67. This region is graphically depicted in FIG. 20 as the region being bound by lines F, H, I and J.

In embodiments, colored glass articles that appear green in color may have a transmitted color coordinate in the CIELAB color space, as measured as measured at an article thickness of 0.5 mm-1.4 mm under F2 illumination and a 100 standard observer angle, of L* greater than or equal to 4 and less than or equal to 80 and a* and b* values within a region of the a* vs. b* color space bound by the intersection of the lines: b*=0.2879·a*+27.818; a*=0; b*=−1.375·a*+1; and b*=9.333·a*+86.667. This region is graphically depicted in FIG. 20 as the region being bound by lines A, K, L, and M.

In embodiments, colored glass articles that appear pink/purple in color may have a transmitted color coordinate in the CIELAB color space, as measured at an article thickness of 0.5 mm-1.4 mm under F2 illumination and a 10° standard observer angle, of L* greater than or equal to 10 and less than or equal to 80 and a* and b* values within a region of the a* vs. b* color space bound by the intersection of the lines: b*=0.0833·a*+20.833; b*=2.1182·a*−32.073; b*=−0.3; and b*=1.5929·a*−0.3. This region is graphically depicted in FIG. 20 as the region being bound by lines N, O, P and Q.

The colored glass articles described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a colored glass article as described herein. The colored glass ceramic articles described herein may also be used as “windows” in the housings of sensors detecting wavelengths of light outside the visible spectrum (e.g., short wave infrared (IR), mid-wave IR, long wave IR, far wave IR). Such applications may include passive IR sensors, thermopile IR sensors, IR photodiodes, IR emitters (LEDs), IR Receivers, photo interrupters, photo reflectors, tilt sensors, IR linear arrays, communication modules (IrDA, IrDA-SIR, IrDA-MIR, IrDA-FIR). Such sensors may be employed in, for example and without limitation, night vision systems, climate control systems, pedestrian detection systems for vehicles, assisted parking detection systems for vehicles, distance measurement systems, vehicle to vehicle communication systems, collision avoidance systems, temperature sensors, fall detection systems, heart rate monitors, pulse oximetry systems, blood glucose monitor systems, pressure monitoring systems, optical coherence tomography systems, imaging systems, photo voltaic electroluminescence inspection systems, thermal imaging systems, illumination systems, precision guided munition systems, missile tracking systems, LiDAR systems, residential control systems, home appliances, entertainment devices, printers, computers, gaming devices, toys, security and surveillance systems.

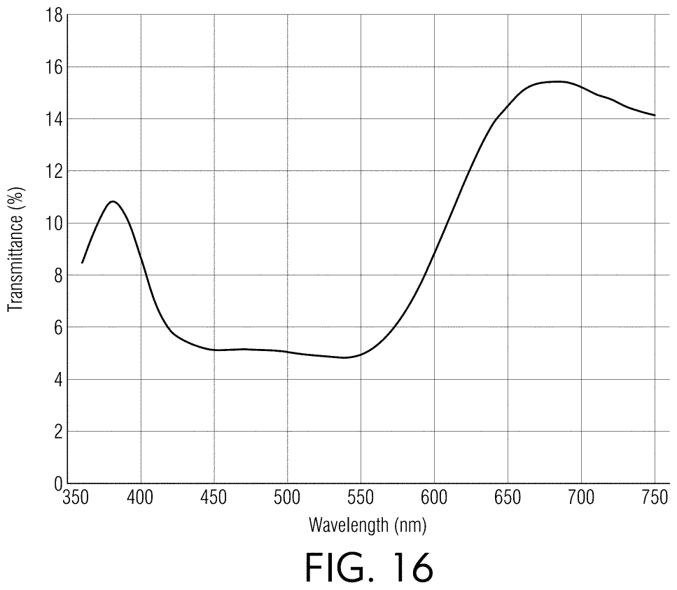

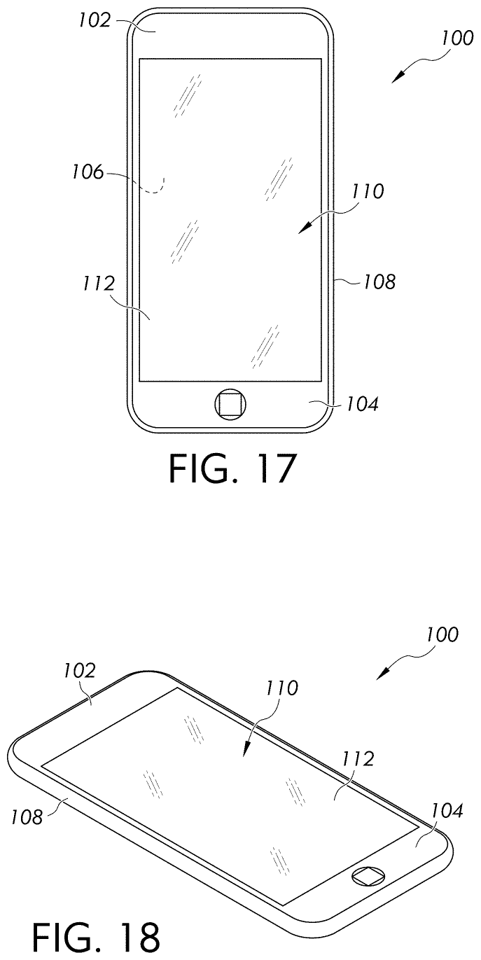

An example electronic device incorporating any of the colored glass articles disclosed herein is shown in FIGS. 17 and 18. Specifically, FIGS. 17 and 18 show a consumer electronic device 100 including a housing 102 having front 104, back 106, and side surfaces 108; electrical components (not shown) that are at least partially inside or entirely within the housing and including at least a controller, a memory, and a display 110 at or adjacent to the front surface of the housing; and a cover substrate 112 at or over the front surface of the housing such that it is over the display. In embodiments, at least a portion of at least one of the cover substrate 112 and the housing 102 may include any of the colored glass articles disclosed herein.

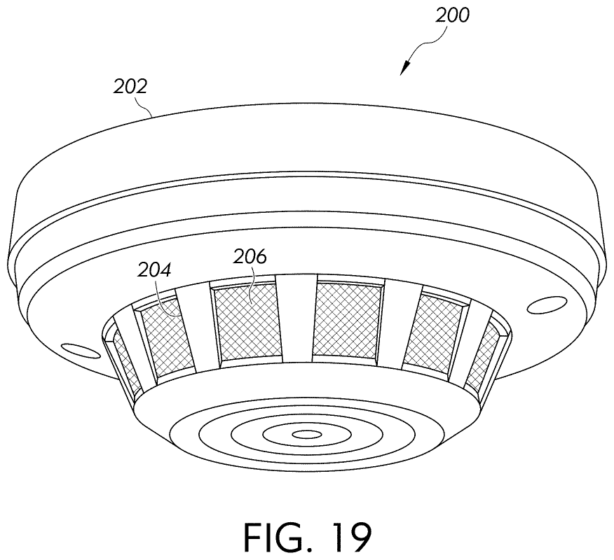

Referring now to FIG. 19, an example sensor device 200 incorporating a colored glass articles as disclosed herein is shown. Specifically, FIG. 19 depicts a sensor device 200 including a housing 202; one or more sensors (e.g., infrared sensors or the like (not depicted)) may be disposed at least partially inside or entirely inside the housing and positioned within an aperture 204 of the housing; and an aperture cover 206 at or over the aperture 204. The aperture cover 206 may be a colored glass article as described herein and having a black or dark green color while being highly transparent to infrared light, thereby concealing the sensor within the housing while still allowing wavelengths or infrared light to reach the sensor.

Specifically, it has been discovered that, in embodiments, the colored glass articles of the present disclosure may have an optical absorbance that is well-suited for LiDAR (light detection and ranging) cover applications. These covers require less than 3% average transmittance in the visible range and greater than 90% average transmittance in the near-infrared (NIR) range at a thicknesses less than 3 mm. Accordingly, in the embodiment depicted in FIG. 19, the sensor device 200 may be a LiDAR sensor. However, other technologies are contemplated and possible, such as NIR cameras, proximity sensors, laser range finders, etc., operating at NIR wavelengths that require “black” (i.e., near black) cover glasses. Such applications may also require transparency in the NIR and also RF transparency for communication.

Accordingly, it should be understood that, in some embodiments, the colored glass article may have a thickness (τ_{w}) less than or equal to 3.00 mm with an average IR transmittance greater than 90% for wavelengths greater than or equal to 780 nm and less than or equal to 2,000 nm and an average transmittance less than 3% for wavelengths greater than or equal to 380 nm and less than 750 nm.

### Examples

The following examples illustrate one or more features of the present disclosure. It should be understood that these examples are not intended to limit the scope of the present disclosure or the appended claims.

Exemplary glass compositions of the present disclosure are reported in Tables 1 and 2.

TABLE 1

| Sample # | 1 | 2 | 3 | 4 | 5 | 6 | 7 | 8 | 9 | 10 | 11 | 12 | 13 |
|---|---|---|---|---|---|---|---|---|---|---|---|---|---|
| SiO₂ (mol. %) | 59.55 | 60.05 | 60.55 | 60.00 | 59.95 | 59.90 | 60.10 | 60.00 | 59.85 | 60.16 | 60.09 | 59.79 | 59.47 |
| Al₂O₃ (mol. %) | 16.50 | 16.50 | 16.50 | 16.50 | 16.50 | 16.50 | 16.50 | 16.50 | 16.50 | 15.90 | 15.93 | 15.89 | 15.82 |
| B₂O₃ (mol. %) | 6.00 | 6.00 | 6.00 | 6.00 | 6.00 | 6.00 | 6.00 | 6.00 | 6.00 | 6.08 | 6.06 | 6.04 | 5.99 |
| Li₂O (mol. %) | 12.00 | 12.00 | 12.00 | 12.00 | 12.00 | 12.00 | 12.00 | 12.00 | 12.00 | 11.99 | 11.97 | 11.97 | 11.92 |
| Na₂O (mol. %) | 5.70 | 5.20 | 4.70 | 5.20 | 5.20 | 5.20 | 5.20 | 5.20 | 5.20 | 5.41 | 5.41 | 5.89 | 6.37 |
| K₂O (mol. %) | — | — | — | — | — | — | — | — | — | 0.20 | 0.20 | 0.20 | 0.19 |
| SnO₂ (mol. %) | 0.10 | 0.10 | 0.10 | 0.10 | 0.10 | 0.10 | 0.10 | 0.10 | 0.10 | 0.11 | 0.11 | 0.11 | 0.10 |
| Ag (mol. %) | 0.15 | 0.15 | 0.15 | 0.15 | 0.15 | 0.15 | 0.10 | 0.10 | 0.25 | 0.15 | 0.25 | 0.12 | 0.13 |
| CeO₂ (mol. %) | — | — | — | 0.05 | 0.10 | 0.15 | — | 0.10 | 0.10 | — | — | — | — |
| Nd₂O₃ (mol. %) | — | — | — | — | — | — | — | — | — | — | — | — | — |
| Er₂O₃ (mol. %) | — | — | — | — | — | — | — | — | — | — | — | — | — |
| R₂O—Al₂O₃ (mol. %) | 1.20 | 0.70 | 0.20 | 0.70 | 0.70 | 0.70 | 0.70 | 0.70 | 0.70 | 1.70 | 1.64 | 2.16 | 2.66 |

TABLE 2

| Sample # | 14 | 15 | 16 | 17 | 18 | 19 | 20 | 21 | 22 | 23 | 24 | 25 | 26 | 27 |
|---|---|---|---|---|---|---|---|---|---|---|---|---|---|---|
| SiO₂ (mol. %) | 59.45 | 57.55 | 57.55 | 59.1 | 59.05 | 59.41 | 59.31 | 59.36 | 59.26 | 58.91 | 58.81 | 59.41 | 59.01 | 58.55 |
| Al₂O₃ (mol. %) | 16.50 | 16.50 | 16.50 | 16.00 | 16.00 | 15.97 | 15.97 | 15.97 | 15.97 | 15.97 | 15.97 | 15.97 | 15.89 | 16.5 |
| B₂O₃ (mol. %) | 6.00 | 6.00 | 6.00 | 6.00 | 6.00 | 6.00 | 6.00 | 6.00 | 6.00 | 6.00 | 6.00 | 6.00 | 6.00 | 6 |
| Li₂O (mol. %) | 12.00 | 12.00 | 12.00 | 12.00 | 12.00 | 12.00 | 12.00 | 12.00 | 12.00 | 12.00 | 12.00 | 12.00 | 12.00 | 12 |
| Na₂O (mol. %) | 5.50 | 6.50 | 6.50 | 6.50 | 6.50 | 6.17 | 6.17 | 6.17 | 6.17 | 6.67 | 6.67 | 6.17 | 6.65 | 6.5 |
| K₂O (mol. %) | 0.20 | 0.20 | 0.20 | 0.20 | 0.20 | 0.20 | 0.20 | 0.20 | 0.20 | 0.20 | 0.20 | 0.20 | 0.20 | 0.2 |
| SnO₂ (mol. %) | 0.20 | 0.10 | 0.10 | 0.10 | 0.10 | 0.10 | 0.20 | 0.10 | 0.20 | 0.10 | 0.20 | 0.10 | 0.10 | 0.1 |
| Ag (mol. %) | 0.15 | 0.15 | 0.15 | 0.10 | 0.15 | 0.15 | 0.15 | 0.20 | 0.20 | 0.15 | 0.15 | 0.15 | 0.15 | 0.15 |
| CeO₂ (mol. %) | — | — | — | — | — | — | — | — | — | — | — | — | — | — |
| Nd₂O₃ (mol. %) | — | 1.00 | — | — | — | — | — | — | — | — | — | — | — | — |
| Er₂O₃ (mol. %) | — | — | 1.00 | — | — | — | — | — | — | — | — | — | — | — |
| R₂O—Al₂O₃ (mol. %) | 1.20 | 2.20 | 2.20 | 2.70 | 2.70 | 2.40 | 2.40 | 2.40 | 2.40 | 2.90 | 2.90 | 2.40 | 2.96 | 2.2 |

The exemplary glass compositions of Tables 1 and 2 were used to produce glass coupons. These glass coupons were inserted into pre-heated, ambient-air electric ovens, held for a desired amount of time, and cooled in air to produce colored glass coupons. It should be noted that some glasses were heated at a particular ramp rate and/or cooled at a controlled rate; however, it was determined that neither the ramp rate nor cooling rate affected color generation.

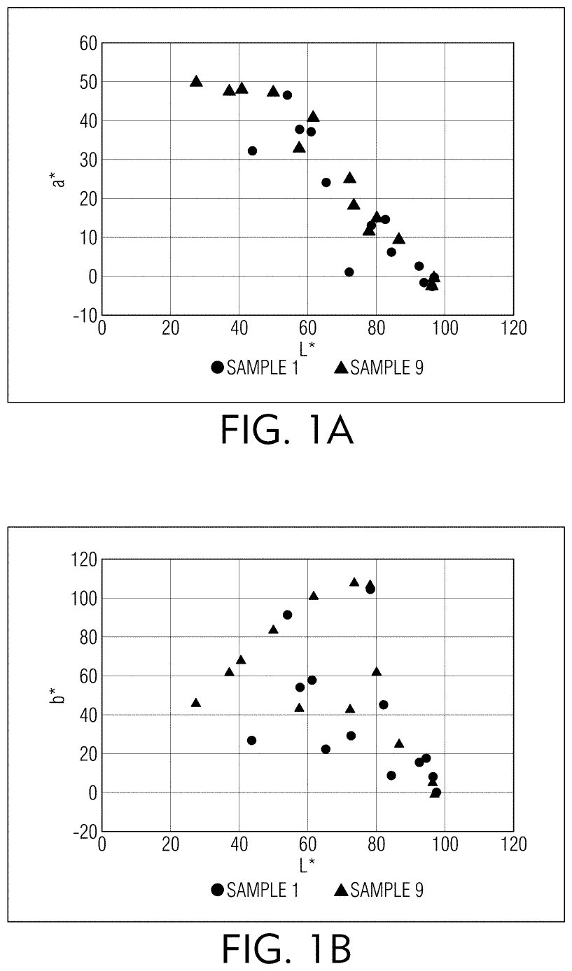

Plots of CIELAB spaces of colored glass coupons produced from Samples 1 and 9 are depicted in FIG. 1A (a* vs. L*), FIG. 1B (b* vs. L*), and FIG. 1C (a* vs. b*). Sample sets having thicknesses of 0.6 mm, 1.33 mm, and 2.06 mm were made from each composition and the samples were heat treated at various heat treatment times (575° C., 600° C., 625° C., 650° C.) and various heat treatment times (1 hour, 2 hours) to produce colored glass articles having the CIELAB L*, a*, b* values indicated in FIGS. 1A-1C.

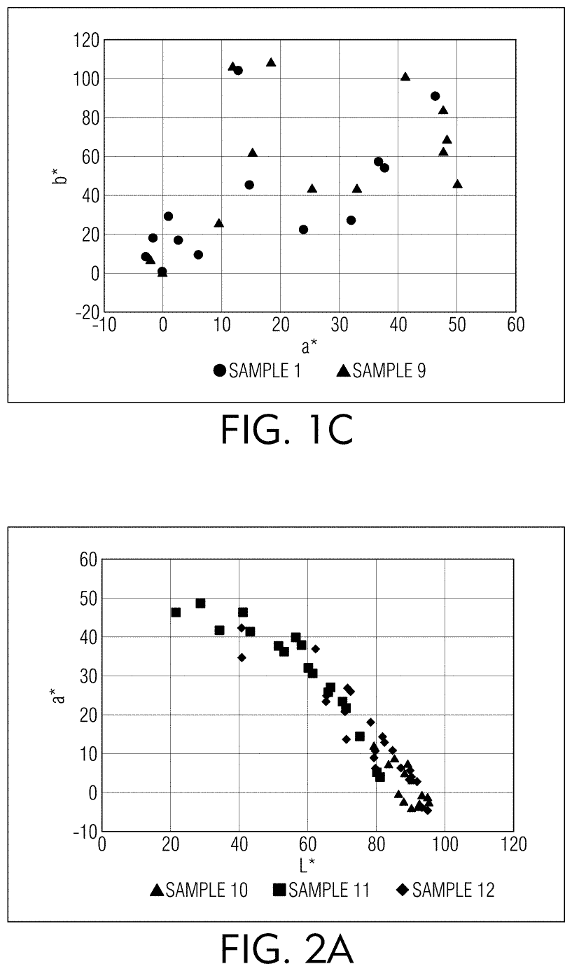

Plots of projected CIELAB spaces of colored glass coupons produced from Samples 10-12 are depicted in FIG. 2A (a* vs. L*), FIG. 2B (b* vs. L*), and FIG. 2C (a* vs. b*). Sample sets having thicknesses of 0.6 mm, 1.33 mm, and 2.06 mm were made from each composition and the samples were heat treated at various heat treatment times (575° C., 600° C., 625° C., 650° C.) and various heat treatment times (1 hour, 2 hours) to produce colored glass articles having the CIELAB L*, a*, b* values indicated in FIGS. 2A-2C.

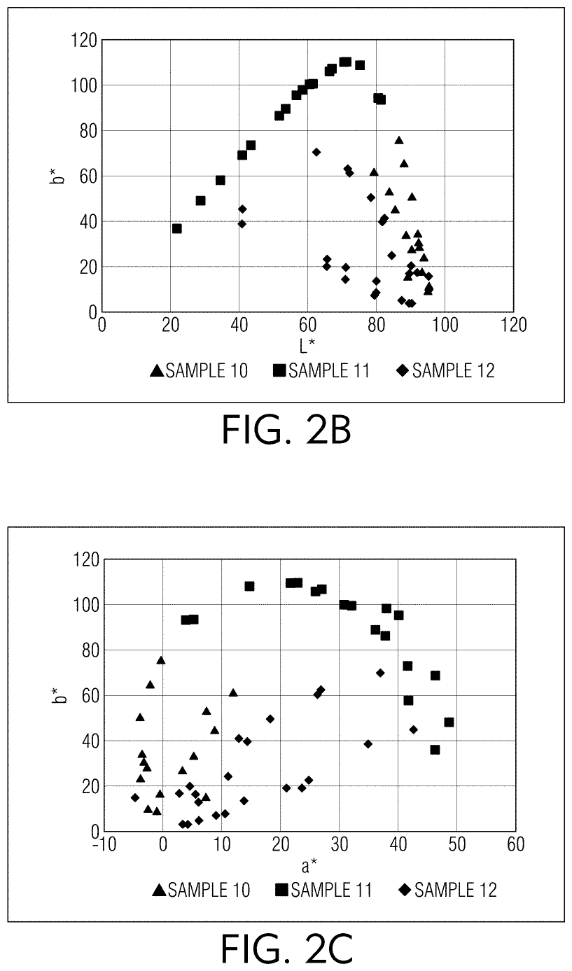

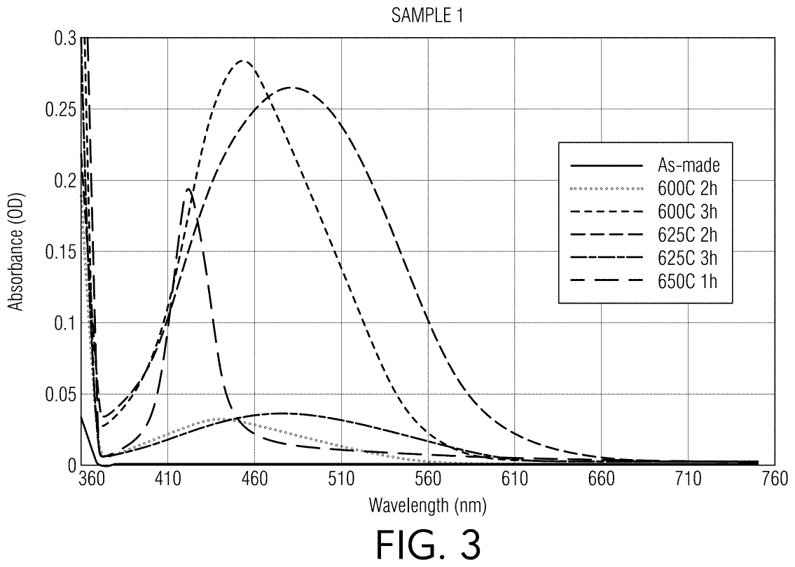

FIGS. 3 and 4 depict the absorbance spectra (determined from the transmittance spectra T where the absorbance A=log₁₀(1/T)) of colored glass coupons produced from Samples 1 and 9, respectively. Specifically, the absorbance spectra of glass coupons formed from the compositions of Samples 1 and 9 were collected from coupons in: as-made condition (no heat treatment); after exposure to a heat treatment of 600° C. for 2 hours; after exposure to a heat treatment of 600° C. for 3 hours; after exposure to a heat treatment of 625° C. for 2 hours; after exposure to a heat treatment of 625° C. for 3 hours; and after exposure to a heat treatment of 650° C. for 3 hours. As shown in FIGS. 3 and 4, the absorbance spectra varied considerably with changes in heat treatment temperature and heat treatment time.

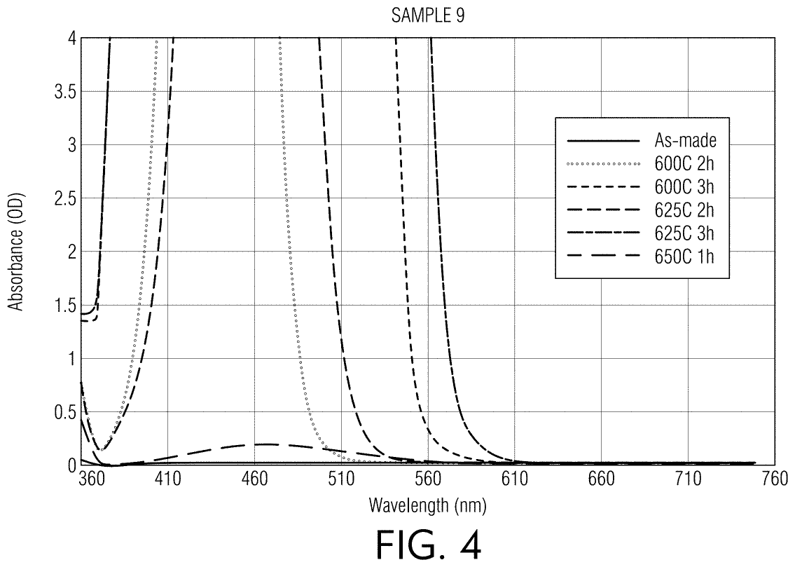

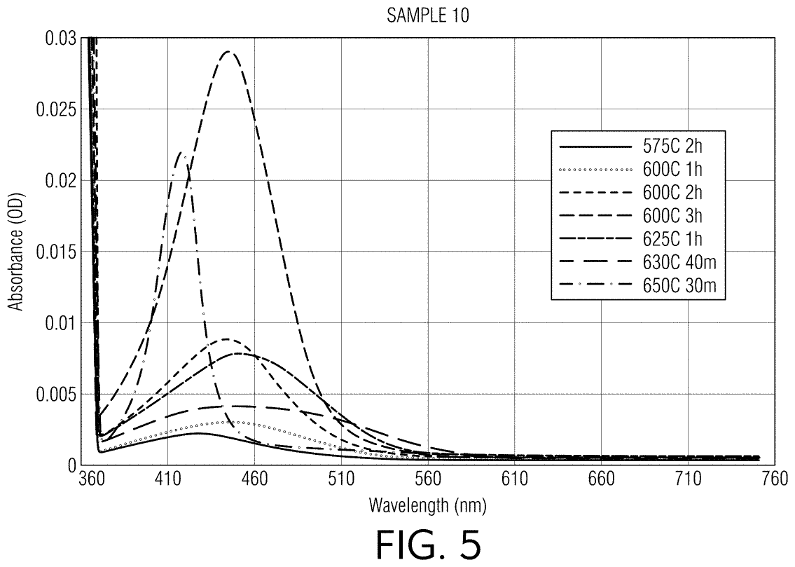

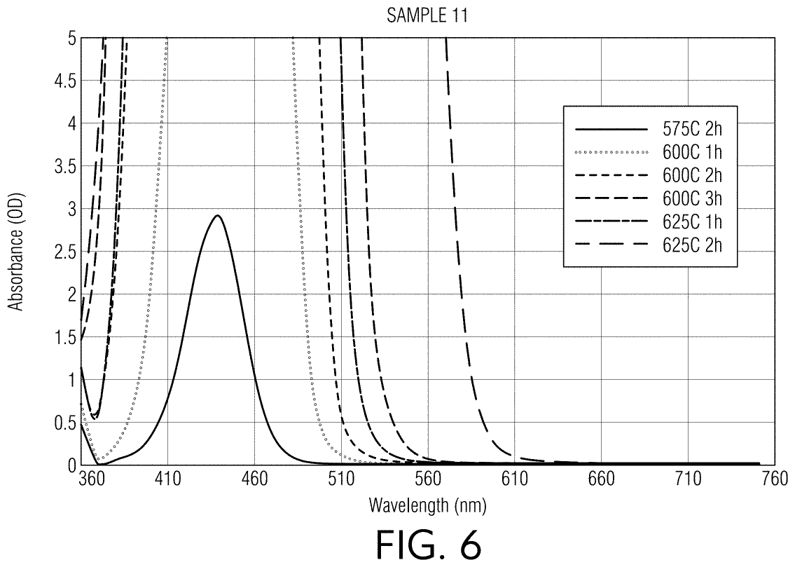

FIGS. 5, 6 and 7 depict the absorbance spectra of colored glass coupons produced from Samples 10-12, respectively. Specifically, the absorbance spectra of glass coupons formed from the compositions of samples 10-12 were collected from coupons in: after exposure to a heat treatment of 575° C. for 2 hours; after exposure to a heat treatment of 600° C. for 1 hours; after exposure to a heat treatment of 600° C. for 2 hours; after exposure to a heat treatment of 600° C. for 3 hours; after exposure to a heat treatment of 625° C. for 1 hour; after exposure to a heat treatment of 630° C. for 4 hours; and after exposure to a heat treatment of 650° C. for 0.5 hour. As shown in FIGS. 5-7, the absorbance spectra varied considerably with changes in heat treatment temperature and heat treatment time.

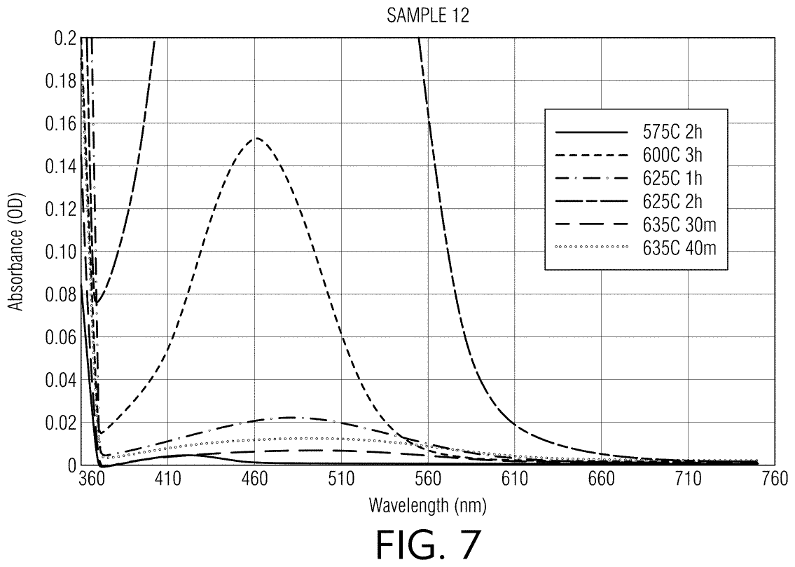

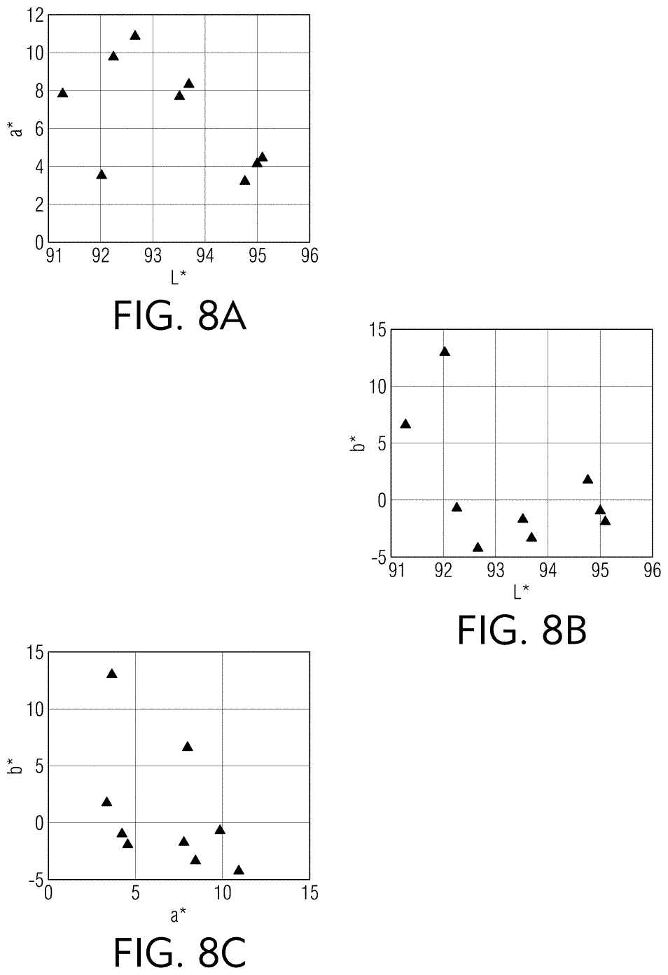

FIGS. 8A-8C are plots of CIELAB spaces of colored glass coupons produced from Sample 16 containing erbium. Specifically FIG. 8A is a plot of a* vs. L*, FIG. 8B is a plot b* vs. L*, and FIG. 8C is a plot of a* vs. b*. Sample sets having thicknesses of ˜0.6 mm, ˜1.33 mm, and ˜2.06 mm were made from the composition and heat treated at various heat treatment temperatures and various heat treatment times (as indicated in Table 3) to produce colored glass articles having the CIELAB L*, a*, b* values indicated in FIGS. 8A-8C. The CIELAB space plots indicate that an entirely new range of colors can be achieved by adding erbium to the composition. FIG. 9 depicts the absorbance spectra of sample 16 in as-made condition (prior to heat treatment); after heat treatment at 565° C. for 15 minutes; and after heat treatment at 575° C. after 20 minutes.

TABLE 3

| | Heat Treatment | | | | |
|---|---|---|---|---|---|
| | (Temp (° C.)/ | Thick- | | | |
| | Time (minutes)/ | ness | | | |
| Sample | Ramp Rate (° C./min)) | (mm) | L* | a* | b* |
| 16 | as made | 0.60 | 95.09 | 4.58 | −1.73 |
| 16 | 575/20/10 | 0.57 | 94.76 | 3.32 | 1.91 |
| 16 | 565/15/10 | 0.60 | 95 | 4.26 | −0.83 |
| 16 | as made | 1.34 | 93.7 | 8.44 | −3.23 |
| 16 | 575/20/10 | 1.32 | 92.03 | 3.62 | 13.15 |
| 16 | 565/15/10 | 1.32 | 93.51 | 7.83 | −1.61 |
| 16 | as made | 2.06 | 92.66 | 10.98 | −4.12 |
| 16 | 575/20/10 | 2.03 | 91.28 | 7.96 | 6.77 |
| 16 | 565/15/10 | 2.04 | 92.25 | 9.9 | −0.62 |

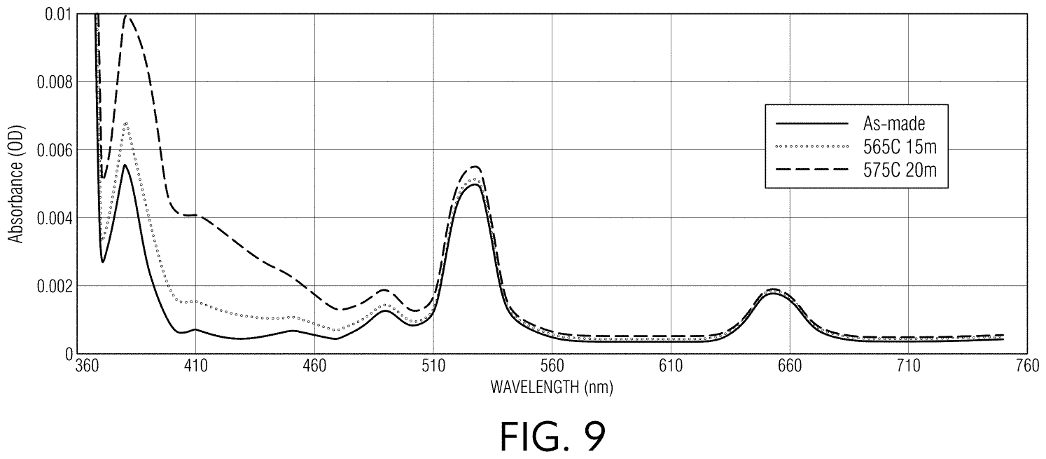

FIGS. 10A-10C are plots of CIELAB spaces of colored glass coupons produced from Sample 13. In particular, coupons of glass formed from the composition of Sample 13 includes R₂O—Al₂O₃ values in the range between 2.5 and 3 mol. %, specifically 2.66 mol. %. The samples were heat treated at various heat treatment temperatures and heat treatment times to produce colored glass articles having a range of colors including green, brown, maroon, purple and pink, as indicated in the CIELAB spaces of FIGS. 10A-10C.

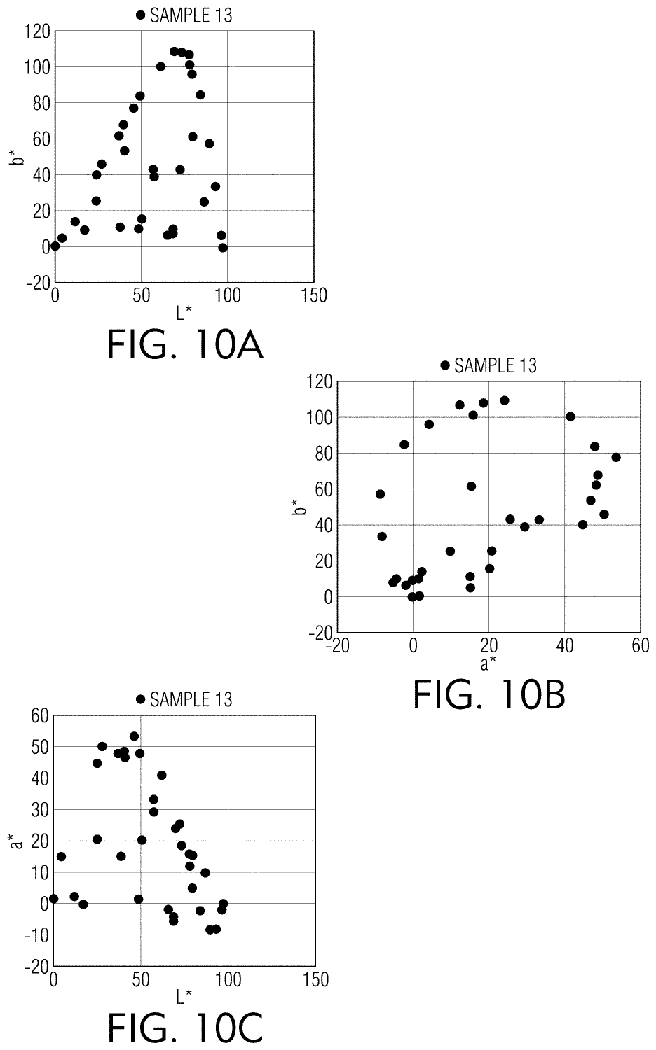

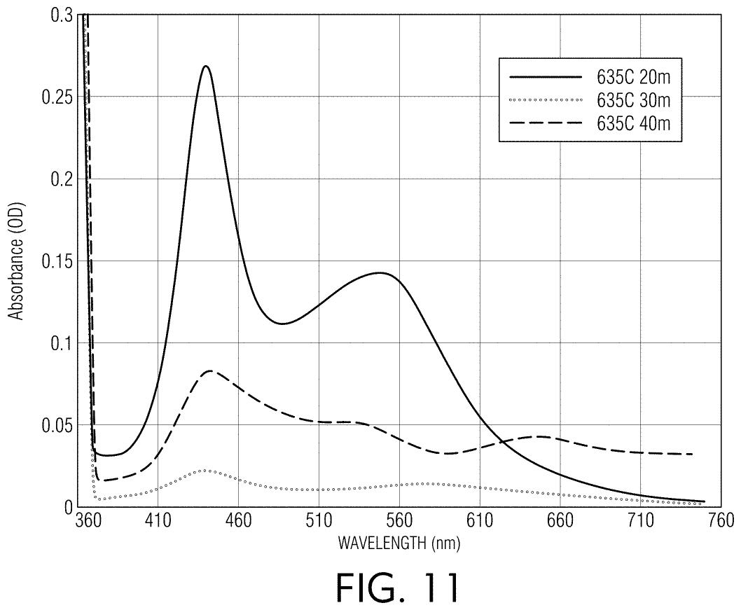

FIG. 11 is the absorbance spectra of Sample 13 for heat treatments at 635° C. for 20 minutes; 635° C. for 30 minutes; and 635° C. for 40 minutes. The heat treatment conditions produced a colored glass article that was green in color. As shown in FIG. 11 the absorbance spectra had two distinct peaks arising from the formation of anisotropic silver particles that support two distinct plasmon resonances. FIGS. 12A-12C are TEM micrographs of the anisotropic silver particles in the green glass formed from Sample 13 and show the random orientation of the anisotropic particles (FIG. 12A) and that the silver particles have an aspect ratio greater than 1 (FIGS. 12B and 12C).

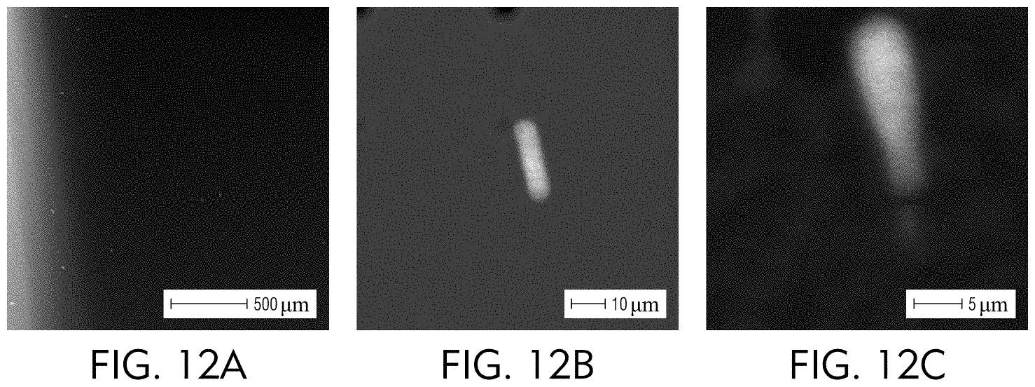

Referring now to FIG. 13, a 1.25 mm thick glass coupon was produced from the composition of Sample 13. The glass coupon was then heat treated at 635° C. for 35 minutes to produce a colored glass coupon. A transmittance spectra of the colored glass coupons produced from Sample 13 is depicted in FIG. 13. As indicated by FIG. 13, the colored glass coupon is sufficient to meet all LiDAR applications (i.e., >90% average transmittance in the IR range, <3% average transmittance in the visible range, and a thickness <3 mm).

As discussed herein, the R₂O—Al₂O₃ value of a composition influences both isotropic and anisotropic particle formation during heat treatment and hence the color of the resultant glass. When R₂O—Al₂O₃<<1 (i.e., 0.2 mol. % or less), virtually no color is formed in the glass upon heat treatment. This is demonstrated by Sample 3, which has an R₂O—Al₂O₃ value of 0.2 mol. %. Irrespective of heat treatment, the glass of Sample 3 remained nearly colorless and transparent after heat treatment. However, when the R₂O—Al₂O₃ value is increased to 0.7 mol % (as with glasses formed from Sample 2) and then to 1.2 mol % (as with glasses formed from Sample 1), a progressively broader and more saturated range of colors were produced by heat treatment.

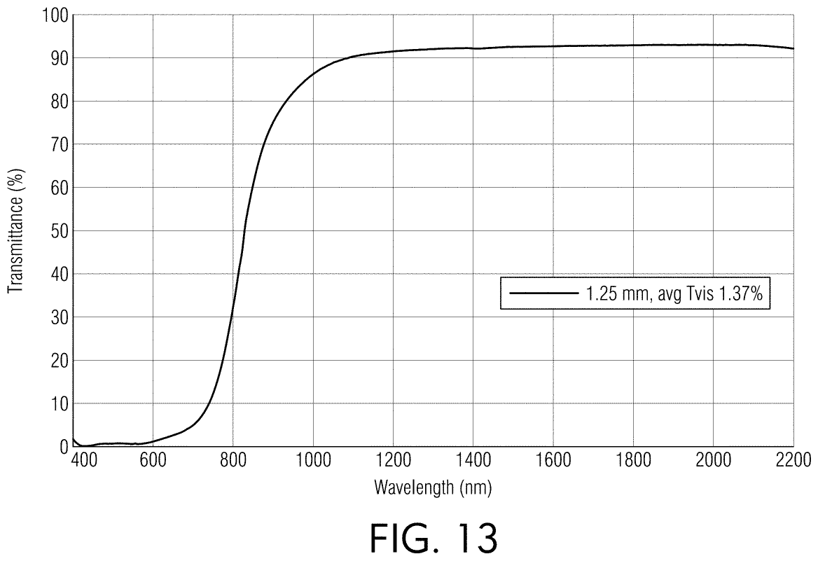

Referring now to FIG. 14, a transmittance spectrum is shown for 1.3 mm coupons of glass formed from Sample 1 and heat treated at the same heat treatment temperature (600° C.) for different heat treatment times (1, 2, or 3 hours). The different heat treatment conditions yielded colored glass articles of different colors (yellow (solid line in FIG. 14), orange (dotted line in FIG. 14), and red (dashed line in FIG. 14), respectively), each of which had different transmittance spectra over the visible light range, as indicated in FIG. 14, with yellow samples being the most transparent and the red samples the least.

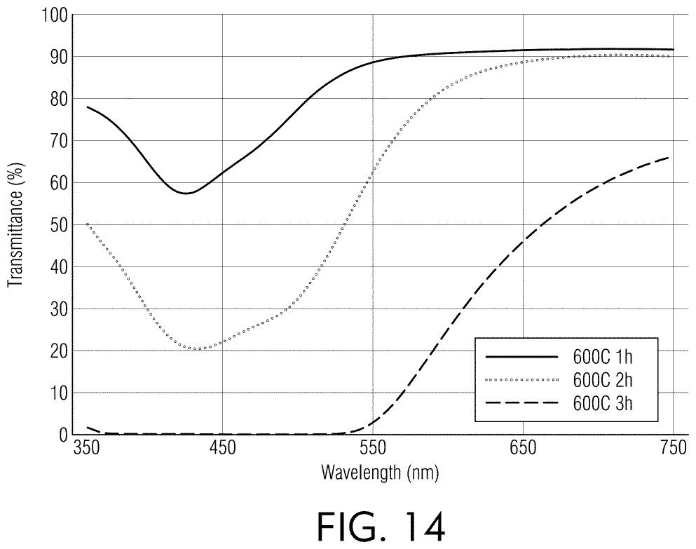

Referring now to FIG. 15, a transmittance spectrum is shown for a 1.3 mm coupon of glass formed from Sample 1 and heat treated at a heat treatment temperature of 650° C. for a heat treatment time of 1 hour, producing a colored glass article that was brown in color. As noted herein, colored glass articles that are brown in color can be produced by heat treatment at temperatures between 640° C. and 660° C. for heat treatment times between 30 and 90 minutes.

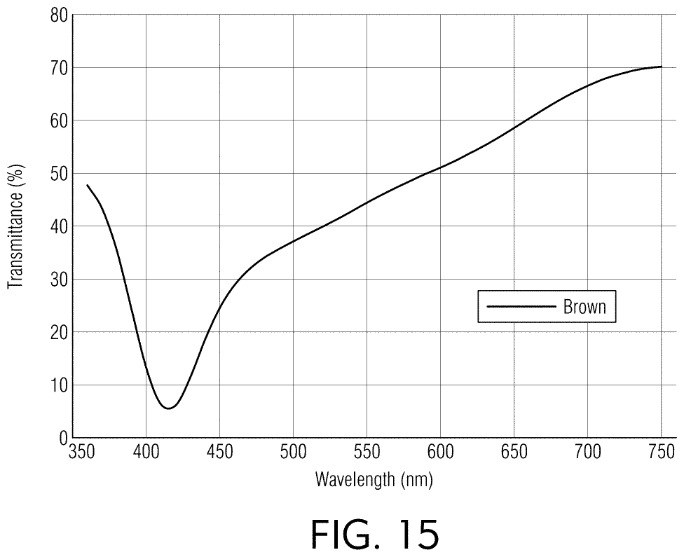

Referring now to FIG. 16, a transmittance spectrum is shown for a 1.3 mm coupon of glass formed from Sample 21 and heat treated with an initial heat treatment of 450° C. for 1 our followed by a second heat treatment of 635° C. for 1 hour, producing a colored glass article that was purple in color. It was determined that the initial heat treatment was not needed to produce color in the sample. As noted herein, colored glass articles that are purple in color can be produced by heat treatment at temperatures between 625° C. and 650° C. for heat treatment times between 30 and 90 minutes.

Referring now to Table 4 and FIG. 20, colored glass articles in the form of glass coupons were produced from the glass compositions of Tables 1 and 2. The glass coupons had thicknesses from ˜0.5 mm to ˜1.4 mm and were heat treated at various times and temperatures (as specified in Table 4) to produce colored glass articles with different color hues. PHCFR means that the glass coupon was placed directly into a pre-heated furnace, held for the indicated time, at which point the furnace was switched off and the glass coupon was cooled in the furnace at the cooling rate of the furnace (typically 2-3° C./minute). PHAC means that the glass coupon was placed directly into a pre-heated furnace, held for the indicated time, then removed and allowed to cool back to room temperature in ambient air. The CIELAB L*, a*, and b* coordinates of each colored glass article were determined and the a*, b* color coordinates were plotted as depicted in FIG. 20, where the x-axis is the a* coordinate and the y-axis is the b* coordinate. For reference, the L* coordinate (not depicted) is along an axis orthogonal to both the x-axis and the y-axis of FIG. 20 and extends through the point a*=0 and b*=0.

TABLE 4

| | Heat Treatment | | | | |
|---|---|---|---|---|---|
| | (Temp (° C.)/ | Thick- | | | |
| | Time (minutes)/ | ness | | | |
| Sample | Ramp Rate (° C./min)) | (mm) | L* | a* | b* |
| 10 | 600/3/10 | 1.33 | 88.3 | −2.26 | 65.85 |
| 10 | 600/3/10 | 1.29 | 90.44 | −3.88 | 51.15 |
| 11 | 575/2/10 | 1.29 | 80.43 | 5.3 | 94.46 |
| 11 | 575/2/10 | 1.32 | 81.29 | 3.96 | 93.62 |
| 10 | 600/2/10 | 1.31 | 92.72 | −2.81 | 29.07 |
| 10 | 600/2/10 | 1.28 | 92.55 | −3.22 | 30.79 |
| 10 | 625/2/10 | 1.32 | 83.97 | 7.32 | 53.78 |
| 10 | 625/2/10 | 1.32 | 79.43 | 12.07 | 62 |
| 27 | 600/0.5/PHCFR | 1.26 | 89.41 | −8.22 | 57.36 |
| 27 | 600/0.75/PHCFR | 1.35 | 83.95 | −2.24 | 85.2 |
| 27 | 600/1/PHCFR | 1.32 | 79.51 | 4.83 | 96 |
| 9 | 600/1/PHAC | 1.31 | 77.86 | 12.16 | 106.74 |
| 9 | 600/2/PHAC | 1.31 | 73.48 | 18.67 | 108.37 |
| 1 | 600/1/10 | 1.29 | 78.31 | 13 | 104.03 |
| 13 | 635/0.3/10 | 0.61 | 78.07 | 16.01 | 101.22 |
| 11 | 635/0.5/10 | 0.59 | 76.1 | 18.64 | 111.37 |
| 23 | 625/0.5/10 | 1.28 | 86.72 | −2.66 | 91.23 |
| 23 | 450/111/10 | 1.25 | 81.15 | 6.31 | 103.91 |
| 21 | 575/2/10 | 1.16 | 90.82 | −7.55 | 56.94 |
| 23 | 575/2/10 | 1.23 | 90.94 | −9.74 | 52.14 |
| 23 | 575/3/10 | 1.35 | 83.93 | −2.13 | 87.35 |
| 23 | 600/1/10 | 1.33 | 88.97 | −7.73 | 76.89 |
| 23 | 625/0.75/10 | 1.37 | 77.37 | 13.14 | 107.83 |
| 23 | 650/0.3/10 | 1.32 | 83.6 | 3.6 | 98.53 |
| 23 | 615/0.5/10 | 1.33 | 90.72 | −11.12 | 66.64 |
| 23 | 615/1/10 | 1.29 | 78.19 | 13.1 | 108.41 |
| 23 | 640/0.5/10 | 1.25 | 73.27 | 21.82 | 101.59 |
| 23 | 650/0.5/10 | 1.29 | 77.89 | 7.06 | 92.68 |
| 22 | 575/3/10 | 1.34 | 78.23 | 13.57 | 100.58 |
| 24 | 575/3/10 | 1.34 | 89.53 | 1.16 | 40.46 |
| 20 | 625/2/10 | 1.37 | 83.21 | 9.05 | 39.01 |
| 19 | 575/4/10 | 1.35 | 83.86 | 10.63 | 45.29 |
| 22 | 600/1/10 | 1.31 | 83.83 | 10.63 | 46.05 |
| 21 | 615/0.5/10 | 1.35 | 63.83 | 21.26 | 79.15 |
| 23 | 635/0.6/10 | 1.26 | 69.96 | 24.92 | 104.44 |
| 27 | 600/1.25/PHCFR | 1.31 | 69.76 | 24.11 | 109.37 |
| 21 | 575/3/10 | 1.35 | 75.48 | 20.79 | 106.6 |
| 11 | 600/1/10 | 1.32 | 71.5 | 21.65 | 110.29 |
| 11 | 600/1/10 | 1.33 | 70.48 | 23.07 | 110.67 |
| 9 | 625/1/PHAC | 1.31 | 79.96 | 15.43 | 62.16 |
| 22 | 575/2/10 | 1.20 | 91.99 | −4.71 | 37.28 |
| 11 | 650/0.5/10 | 1.35 | 93.59 | −10.87 | 39.72 |
| 1 | 600/2/PHAC | 1.31 | 81.94 | 14.76 | 45.2 |
| 12 | 600/2/10 | 1.34 | 82.02 | 14.23 | 39.93 |
| 12 | 600/2/10 | 1.31 | 82.6 | 12.96 | 41.47 |
| 27 | 600/0.25/PHCFR | 1.31 | 93.01 | −7.93 | 33.76 |
| 11 | 600/3/10 | 1.34 | 53.38 | 36.16 | 89.47 |
| 12 | 600/3/10 | 1.32 | 71.89 | 26.88 | 63.17 |
| 12 | 600/3/10 | 1.33 | 72.44 | 26.28 | 61.16 |
| 11 | 600/2/10 | 1.30 | 61.58 | 30.81 | 101 |
| 11 | 600/2/10 | 1.32 | 60.37 | 32.13 | 100.26 |
| 11 | 625/1/10 | 1.33 | 56.78 | 40.08 | 95.88 |
| 11 | 625/1/10 | 1.35 | 58.43 | 38.04 | 98.02 |
| 1 | 600/3/PHAC | 1.32 | 60.97 | 36.89 | 57.26 |
| 9 | 625/2/PHAC | 1.32 | 61.72 | 41.44 | 100.95 |
| 9 | 650/1/PHAC | 1.32 | 57.39 | 33.25 | 43.5 |
| 1 | 600/2/10 | 1.33 | 54.05 | 46.56 | 90.95 |
| 1 | 600/3/10 | 1.32 | 57.71 | 37.75 | 53.96 |
| 9 | 600/3/10 | 1.32 | 49.88 | 47.94 | 84.03 |
| 11 | 635/0.3/10 | 1.36 | 63.67 | 36.89 | 105.88 |
| 11 | 635/0.5/10 | 1.32 | 60 | 39.32 | 100.53 |
| 11 | 630/0.6/10 | 0.59 | 67.2 | 32.97 | 110.25 |
| 11 | 650/0.5/10 | 0.56 | 61.12 | 27.94 | 74.46 |
| 21 | 600/1/10 | 1.33 | 74.55 | 21.53 | 41.51 |
| 22 | 625/1/10 | 1.35 | 57.25 | 32.53 | 43.57 |
| 22 | 625/2/10 | 1.35 | 39.71 | 34.72 | 46.35 |
| 22 | 575/4/10 | 1.37 | 66.13 | 32.1 | 107.91 |
| 23 | 575/4/10 | 1.37 | 61.84 | 37.63 | 102.88 |
| 22 | 600/2/10 | 1.28 | 64.47 | 34.95 | 82.43 |
| 23 | 600/2/10 | 1.25 | 58.86 | 39.89 | 98.15 |
| 22 | 600/3/10 | 1.24 | 62.11 | 37.06 | 96.27 |
| 22 | 635/1/10 | 1.27 | 54.92 | 30.14 | 34.44 |
| 22 | 635/2/10 | 1.28 | 42.76 | 29.96 | 47.39 |
| 22 | 650/30/10 | 1.31 | 47.96 | 24.34 | 42.2 |
| 11 | 600/3/10 | 1.32 | 43.41 | 41.48 | 73.52 |
| 9 | 600 0.5/10 | 1.33 | 72.32 | 25.62 | 43.19 |
| 24 | 575/4/10 | 1.35 | 73.2 | 19.64 | 35.14 |
| 11 | 625/2/10 | 1.31 | 21.62 | 46.36 | 36.66 |
| 11 | 625/2/10 | 1.30 | 28.68 | 48.69 | 48.74 |
| 27 | 600/1.5/PHCFR | 1.31 | 46.01 | 53.51 | 77.81 |
| 9 | 600/3/PHAC | 1.31 | 37.09 | 48.11 | 62.4 |
| 9 | 625/3/PHAC | 1.29 | 27.58 | 50.33 | 46.01 |
| 11 | 650/0.5/10 | 1.35 | 34.47 | 49.12 | 57.71 |
| 21 | 600/2/10 | 1.27 | 25.15 | 38.39 | 41.98 |
| 23 | 600/3/10 | 1.23 | 35.28 | 29.5 | 16.99 |
| 23 | 635/1/10 | 1.27 | 29.58 | 37.33 | 46.53 |
| 9 | 600/2/10 | 1.31 | 40.56 | 48.66 | 68.35 |
| 21 | 575/4/10 | 1.36 | 46 | 51.36 | 75.97 |
| 11 | 630/0.6/10 | 1.35 | 43.57 | 50.81 | 73.87 |
| 22 | 615/1/10 | 1.31 | 45.53 | 48.19 | 73.96 |
| 23 | 625/1/10 | 1.35 | 32.52 | 37.79 | 42.15 |
| 12 | 625/2/10 | 1.31 | 40.9 | 42.34 | 45.72 |
| 12 | 625/2/10 | 1.31 | 40.92 | 34.87 | 38.77 |
| 10 | 575/2/10 | 1.28 | 95.61 | −2.57 | 10.47 |
| 10 | 575/2/10 | 1.33 | 95.5 | −2.51 | 10.73 |
| 12 | 575/2/10 | 1.30 | 95.46 | −4.72 | 15.2 |
| 12 | 575/2/10 | 1.31 | 95.21 | −4.78 | 16.2 |
| 10 | 600/1/10 | 1.29 | 94.06 | −0.93 | 15.68 |
| 10 | 600/1/10 | 1.29 | 95.27 | −1.08 | 9.58 |
| 1 | 575/1/PHAC | 1.30 | 96.33 | −2.88 | 7.92 |
| 9 | 575/1/PHAC | 1.33 | 96.22 | −1.88 | 6.36 |
| 13 | 635/0.5/10 | 0.59 | 65.97 | −1.78 | 6.53 |
| 11 | 635/0.5/10 | 1.34 | 95.37 | −0.8 | 8.8 |
| 11 | 635/0.5/10 | 0.61 | 95.46 | −0.63 | 8.11 |
| 11 | 630/0.7/10 | 1.36 | 94.65 | −1.36 | 13.6 |
| 11 | 630/0.7/10 | 0.57 | 96.13 | −0.64 | 4.96 |
| 13 | 630/0.7/10 | 1.34 | 17.64 | −0.13 | 9.52 |
| 10 | 650/0.5/10 | 0.57 | 93.1 | −2.63 | 16.08 |
| 11 | 650/0.5/10 | 0.58 | 95.83 | −6.92 | 18.3 |
| 13 | 635/0.6/10 | 0.50 | 68.86 | −5.21 | 8.63 |
| 13 | 635/0.6/10 | 0.50 | 69.02 | −4.23 | 10.36 |
| 19 | 625/0.6/10 | 1.28 | 91.48 | −0.24 | 1.94 |
| 19 | 575/2/10 | 1.19 | 96.2 | −1.67 | 5.92 |
| 20 | 575/2/10 | 1.18 | 96.23 | −1.37 | 6.17 |
| 20 | 575/3/10 | 1.36 | 95.79 | −1.76 | 8.63 |
| 20 | 575/4/10 | 1.35 | 94.03 | −2.99 | 21.48 |
| 20 | 600/2/10 | 1.28 | 95.38 | −0.5 | 8.66 |
| 20 | 635/2/10 | 1.29 | 93.27 | −5.41 | 22.51 |
| 24 | 650/0.5/10 | 1.29 | 62.01 | −3.99 | 25.51 |
| 24 | 645/0.5/10 | 1.22 | 53.04 | −2.71 | 16.67 |
| 1 | 600/1/PHAC | 1.30 | 94.18 | −1.61 | 17.89 |
| 20 | 650/0.5/10 | 1.31 | 93.44 | −5.26 | 21.04 |
| 24 | 575/2/10 | 1.21 | 94.46 | −5.08 | 22.99 |
| 20 | 635/2/10 | 1.29 | 93.27 | −5.41 | 22.51 |
| 19 | 575/3/10 | 1.33 | 94.25 | −5.38 | 25.07 |
| 12 | 625/1/10 | 1.34 | 65.54 | 23.63 | 19.56 |
| 12 | 625/1/10 | 1.32 | 71.17 | 21.05 | 19.63 |
| 12 | 635/0.5/10 | 1.35 | 71.32 | 13.82 | 13.62 |
| 1 | 625/3/PHAC | 1.32 | 65.21 | 24.02 | 22.49 |
| 12 | 635/0.5/10 | 1.35 | 64.18 | 18.22 | 17.04 |
| 12 | 635/0.3/10 | 1.35 | 79.6 | 9.04 | 7.31 |
| 13 | 635/0.3/10 | 1.34 | 38.54 | 15.27 | 11 |
| 12 | 635/0.5/10 | 1.34 | 80.09 | 10.51 | 7.99 |
| 12 | 630/0.7/10 | 1.37 | 72.96 | 14.97 | 10.44 |
| 12 | 630/0.7/10 | 0.57 | 87.75 | 6.18 | 4.56 |
| 13 | 650/0.5/10 | 1.36 | 4.61 | 15.13 | 5.16 |
| 22 | 625/0.5/10 | 1.29 | 74.16 | 17.2 | 20.72 |
| 21 | (450/1/10) + (635/0.6/10) | 1.26 | 60.75 | 10.74 | 2.34 |
| 24 | (450/1/10) + (635/0.6/10) | 1.26 | 81.63 | 5.11 | 0.83 |
| 21 | 625/1/10 | 1.33 | 21.04 | 16.09 | 2.81 |
| 24 | 625/1/10 | 1.35 | 69.03 | 7.33 | 0.15 |
| 20 | 635/0.6/10 | 1.28 | 89.93 | 6.67 | 9.6 |
| 21 | 635/0.6/10 | 1.28 | 51.58 | 13.43 | 4.69 |
| 24 | 635/0.6/10 | 1.27 | 78.17 | 7.73 | 2.76 |
| 21 | 600/3/10 | 1.27 | 24.57 | 12.39 | 7.72 |
| 19 | 635/1/10 | 1.28 | 84.58 | 3.58 | 3.24 |
| 21 | 635/1/10 | 1.26 | 40.14 | 10.14 | −0.13 |
| 24 | 635/1/10 | 1.29 | 78.27 | 4.37 | −0.11 |
| 20 | 640/0.5/10 | 1.27 | 89.29 | 7.12 | 9.32 |
| 21 | 640/0.5/10 | 1.28 | 39.19 | 13.64 | 0.14 |
| 22 | 640/0.5/10 | 1.26 | 67.68 | 20.56 | 21.8 |
| 13 | 650/0.5/10 | 0.55 | 50.65 | 20.25 | 15.66 |

As indicated in FIG. 20, the resultant colored glass articles may be grouped into regions of the a*-b* plot according to the hue of the colored glass article. That is, colored glass articles having similar color hues have combinations of discrete a* and b* values that fall within the same region of the a*-b* plot. In particular, colored glass articles that appear yellow have a*, b* values that fall within the region defined by the intersection of four lines: b*=0.2879·a*+27.818 (line A); b*=7.0833·a*−94.5 (line B); b*=0.45·a*+104.5 (line C); and b*=15.3·a*+253 (line D). The region defined by the intersection lines A, B, C, and D can be referred to as the “yellow region” and colored glass articles having combinations of discrete a* and b* values falling within this region will generally appear yellow.

Similarly, colored glass articles that appear orange have a*, b* values that fall within the region defined by the intersection of four lines: b*=7.0833·a*−94.5 (line B); b*=−0.9583·a*+146.75 (line E); b*=2.6957·a*−50.565 (line F); and b*=33 (line G). The region defined by the intersection lines B, E, F, and G can be referred to as the “orange region” and colored glass articles having combinations of discrete a* and b* values falling within this region will generally appear orange.

Still referring to FIG. 20, colored glass articles that appear red have a*, b* values that fall within the region defined by the intersection of four lines: b*=2.6957·a*−50.565 (line F); a*=54 (line H); b*=1.0769·a*−17.154 (line I); and b*=6.6667·a*−173.67 (line J). The region defined by the intersection lines F, H, I, and J can be referred to as the “red region” and colored glass articles having combinations of discrete a* and b* values falling within this region will generally appear orange.

Colored glass articles that appear green have a*, b* values that fall within the region defined by the intersection of four lines: b*=0.2879·a*+27.818 (line A); a*=0 (line K); b*=−1.375·a*+1 (line L); and b*=9.333·a*+86.667 (line M). The region defined by the intersection lines A, L, L, and M can be referred to as the “green region” and colored glass articles having combinations of discrete a* and b* values falling within this region will generally appear green.

Colored glass articles that appear pink/purple have a*, b* values that fall within the region defined by the intersection of four lines: b*=0.0833.a*+20.833 (line N); b*=2.1182·a*−32.073 (line O); b*=−0.3 (line P); and b*=1.5929·a*−0.3 (line Q). The region defined by the intersection lines A, L, L, and M can be referred to as the “pink/purple region” and colored glass articles having combinations of discrete a* and b* values falling within this region will generally appear pink/purple.

Having described the subject matter of the present disclosure in detail and by reference to specific aspects, it is noted that the various details of such aspects should not be taken to imply that these details are essential components of the aspects. Rather, the claims should be taken as the sole representation of the breadth of the present disclosure and the corresponding scope of the various aspects described in this disclosure. Further, it will be apparent that modifications and variations are possible without departing from the scope of the appended claims.

What is claimed:

1. A colored glass article comprising:
greater than or equal to 50 mol. % and less than or equal to 70 mol. % SiO₂;
greater than or equal to 10 mol. % and less than or equal to 20 mol. % Al₂O₃;
greater than or equal to 4 mol. % and less than or equal to 10 mol. % B₂O₃;
greater than or equal to 7 mol. % and less than or equal to 17 mol. % Li₂O;
greater than or equal to 1 mol. % and less than or equal to 9 mol. % Na₂O;
greater than or equal to 0.01 mol. % and less than or equal to 1 mol. % SnO₂; and
greater than or equal to 0.01 mol. % and less than or equal to 5 mol. % Ag,
wherein R₂O—Al₂O₃ is greater than 0.2 mol. % and less than or equal to 5.00 mol. % and R₂O is the sum of Li₂O, Na₂O, and K₂O.

2. The colored glass article of claim 1, wherein the colored glass article is substantially free of halides.

3. The colored glass article of claim 1, wherein the colored glass article, comprises randomly oriented silver particles, the silver particles comprising an aspect ratio greater than 1.

4. The colored glass article of claim 1, wherein the colored glass article comprises greater than or equal to 0.2 mol. % and less than or equal to 1 mol. % K₂O.

5. The colored glass article of claim 1, wherein the colored glass article comprises greater than or equal to 0.05 mol. % and less than or equal to 4 mol. % CeO₂.

6. The colored glass article of claim 1, wherein the colored glass article comprises greater than or equal to 0.1 mol. % and less than or equal to 4 mol. % Nd₂O₃.

7. The colored glass article of claim 1, wherein the colored glass article comprises greater than or equal to 0.1 mol. % and less than or equal to 4 mol. % Er₂O₃.

8. The colored glass article of claim 1, wherein the colored glass article is non-polarized.

9. The colored glass article of claim 1, wherein an absorbance spectra of the glass article comprises two distinct peaks.

10. The colored glass article of claim 1, wherein:
the colored glass article comprises a thickness (τ_{w}) less than or equal to 3.00 mm;
the colored glass article has an average transmittance greater than 90% for wavelengths greater than or equal to 780 nm and less than or equal to 2,000 nm; and
the colored glass article has an average transmittance less than 3% for wavelengths greater than or equal to 380 nm and less than 750 nm.

11. The colored glass article of claim 1, comprising:
greater than or equal to 53 mol. % and less than or equal to 65 mol. % SiO₂;
greater than or equal to 14 mol. % and less than or equal to 17 mol. % Al₂O₃;
greater than or equal to 5 mol. % and less than or equal to 7 mol. % B₂O₃;
greater than or equal to 11 mol. % and less than or equal to 14 mol. % Li₂O;
greater than or equal to 4 mol. % and less than or equal to 7 mol. % Na₂O; and
greater than or equal to 0.1 mol. % and less than or equal to 1 mol. % Ag,
wherein R₂O—Al₂O₃ is greater than 0.50 mol. % and less than or equal to 4.50 mol. %.

12. The colored glass article of claim 1, wherein the colored glass article has a transmitted color coordinate in the CIELAB color space of:
L* greater than or equal 20 and less than or equal to 90; and
a* and b* values within a region of a plot of a* vs. b* bound by the intersection of lines:
b*=0.2879·a*+27.818;
b*=7.0833·a*−94.5;
b*=0.45·a*+104.5; and
b*=15.3·a*+253.

13. The colored glass article of claim 1, wherein the colored glass article has a transmitted color coordinate in the CIELAB color space of:
L* greater than or equal 20 and less than or equal to 90; and
a* and b* values within a region of a plot of a* vs. b* bound by the intersection of lines:
b*=7.0833·a*−94.5;
b*=−0.9583·a*+146.75;
b*=2.6957·a*−50.565; and
b*=33.

14. The colored glass article of claim 1, wherein the colored glass article has a transmitted color coordinate in the CIELAB color space of:
L* greater than or equal 20 and less than or equal to 90; and
a* and b* values within a region of a plot of a* vs. b* bound by the intersection of lines:
b*=2.6957·a*−50.565;
a*=54;
b*=1.0769·a*−17.154; and
b*=6.6667·a*−173.67.

15. The colored glass article of claim 1, wherein the colored glass article has a transmitted color coordinate in the CIELAB color space of:
L* greater than or equal 4 and less than or equal to 80; and
a* and b* values within a region of a plot of a* vs. b* bound by the intersection of lines:
b*=0.2879·a*+27.818;
a*=0;
b*=−1.375·a*+1; and
b*=9.333·a*+86.667.

16. The colored glass article of claim 1, wherein the colored glass article has a transmitted color coordinate in the CIELAB color space of:
L* greater than or equal 10 and less than or equal to 80; and
a* and b* values within a region of a plot of a* vs. b* bound by the intersection of lines:
b*=0.0833·a*+20.833;
b*=2.1182·a*−32.073;
b*=−0.3; and
b*=1.5929·a*−0.3.

17. A glass composition comprising:
greater than or equal to 50 mol. % and less than or equal to 70 mol. % SiO₂;
greater than or equal to 10 mol. % and less than or equal to 20 mol. % Al₂O₃;
greater than or equal to 4 mol. % and less than or equal to 10 mol. % B₂O₃;
greater than or equal to 7 mol. % and less than or equal to 17 mol. % Li₂O;
greater than or equal to 1 mol. % and less than or equal to 9 mol. % Na₂O;
greater than or equal to 0.01 mol. % and less than or equal to 1 mol. % SnO₂;
greater than or equal to 0.01 mol. % and less than or equal to 5 mol. % Ag,
wherein R₂O—Al₂O₃ is greater than 0.2 mol. % and less than or equal to 5 mol. % when R₂O is the sum of Li₂O, Na₂O, and K₂O.

18. The glass composition of claim 17, comprising greater than or equal to 0.05 mol. % and less than or equal to 4 mol. % CeO₂.

19. The glass composition of claim 17, comprising greater than or equal to 0.1 mol. % and less than or equal to 4 mol. % Nd₂O₃.

20. The glass composition of claim 17, comprising greater than or equal to 0.1 mol. % and less than or equal to 4 mol. % Er₂O₃.
